(19) United States
(12) Patent Application Publication
(10) Pub. No.: US 2012/0292578 A1
(43) Pub. Date: Nov. 22, 2012

(54) METHOD FOR PRODUCING COMPOSITE MATERIALS BASED ON POLYMERS AND CARBON NANOTUBES (CNTs), COMPOSITE MATERIALS PRODUCED IN THIS WAY AND USE THEREOF

(76) Inventors: Alexander Bacher, Bruchsal (DE); Michael Berkei, Haltern am See (DE); Eva Potyra, Haltern am See (DE); Jan Diemer, Karlsruhe (DE); Susanne Lüssenheide, Bretten (DE); Jörg Metzge, Leonberg (DE); Helmut Meyer, Odenthal (DE); Irma Mikonsaari, Pfinztal (DE); Thomas Sawitowski, Wesel (DE); Boris Schunke, Achem (DE); Janin Tecklenburg, Oberhausen (DE); Nadine Willing, Emmerich (DE); Adrian Zanki, Hambrucken (DE)

(21) Appl. No.: 13/510,758

(22) PCT Filed: Feb. 8, 2010
(86) PCT No.: PCT/EP10/00757

§ 371 Date: Aug. 3, 2012

(30) Foreign Application Priority Data
Nov. 18, 2009 (EP) EP/2009/008217
Nov. 18, 2009 (EP) EP/2009/008218
Jan. 20, 2010 (EP) EP/2010/000323
Feb. 2, 2010 (EP) EP/2010/000622

(51) Int. Cl. H01B 1/24; B82Y 30/00; B82Y 40/00

(52) U.S. Cl. 252/511; 977/842; 977/742; 977/779; 977/751; 977/752

(57) ABSTRACT

The invention relates to a method for producing composite materials based on at least one polymer and carbon nanotubes (CNTs), and to composite materials obtained in this manner and the use thereof.

### CROSS-REFERENCES TO RELATED APPLICATIONS

This application is a National Stage filing of International Application PCT/EP 2010/000757 filed Feb. 8, 2010, entitled “METHOD FOR PRODUCING COMPOSITE MATERIALS BASED ON POLYMERS AND CARBON NANOTUBES (CNTS), AND COMPOSITE MATERIALS PRODUCED IN THIS MANNER AND THE USE THEREOF” claiming priority to PCT/EP 2009/008217 filed on Nov. 18, 2009, PCT/EP 2009/008218 filed on Nov. 18, 2009, PCT/EP 2010/000323 filed on Jan. 20, 2010 and PCT/EP 2010/000622 filed on Feb. 2, 2010, and incorporates all by reference herein, in their entirety.

### BACKGROUND OF THE INVENTION

The present invention relates to a method for producing composite materials based on at least one polymer on the one hand and carbon nanotubes (CNTs) on the other hand, to composite materials obtainable in this way, and to use thereof.

Carbon nanotubes (CNTs) are microscopic tubular structures (that is to say molecular nanotubes) made of carbon. Their walls consist substantially exclusively of carbon, similarly to fullerenes or the layers of graphite, the carbon atoms adopting a honeycomb-like structure with hexagons and three bonding partners in each case, this structure being provided by the sp² hybridisation of the carbon atoms.

Carbon nanotubes are thus derived from the carbon layers of graphite, which are rolled up into a tube so to speak: The carbon atoms form a honeycomb-like, hexagonal structure having three bonding partners in each case. Tubes having a perfectly hexagonal structure have a uniform thickness and are linear; however, kinked or narrowing tubes which contain pentagonal carbon rings are also possible. Depending on how the honeycomb net of the graphite is rolled into tubes (“straight” or “diagonally”), helical structures (in other words structures wound in a corkscrew-like manner) which are not mirror-symmetrical, that is to say chiral structures, are produced.

A distinction is made between single-wall carbon nanotubes (SWCNTs or SWNTs) and multi-wall carbon nanotubes (MWCNTs or MWNTs), between open and closed carbon nanotubes (that is to say with a “cap”, for example which has a section from a fullerene structure), and between empty and filled carbon nanotubes (for example filled with silver, liquid lead, noble gases, etc.).

The diameter of carbon nanotubes (CNTs) lies in the region of a few nanometres (for example 1 to 50 nm), but carbon nanotubes (CNTs) having diameters of the tubes of only 0.4 nm have also been produced already. Lengths of a few micrometres to millimetres for individual tubes and up to a few centimetres for tube bundles have already been achieved.

According to the prior art, carbon nanotubes (CNTs) are understood in particular to be cylindrical carbon tubes having a diameter between 3 and 100 nm for example and a length which is a multiple of the diameter. These tubes consist of one or more layers of ordered carbon atoms and have a core which differs in terms of morphology. These carbon nanotubes are also known synonymously as “carbon fibrils”, “hollow carbon fibres” or the like, for example.

Carbon nanotubes have long been known in the technical literature. Although Iijima (see publication: S. Iijima, Nature 354, 56-58, 1991) is generally referred to as the discoverer of nanotubes, these materials, in particular fibrous graphite materials having a plurality of graphite layers, have been known since the 1970s and early 1980s. Tates and Baker (see GB 1 469 930 A1 or EP 0 056 004 A2) were the first to describe the separation of very fine fibrous carbon from the catalytic decomposition of hydrocarbons. However, the carbon filaments produced on the basis of short-chain hydrocarbons are not characterised in greater detail in terms of their diameter.

Usual structures of these carbon nanotubes are those of the cylinder type in particular. As described previously, in the case of cylindrical structures in particular, a distinction is made between single-wall carbon nanotubes and multi-wall carbon nanotubes. Examples of usual methods for the production thereof include the arc discharge method, laser ablation, chemical deposition from the vapour phase (CVD process) and catalytic-chemical deposition from the vapour phase (CCVD process).

The formation of carbon tubes by the arc discharge method is known from Iijima, Nature 354, 1991, 56-8: These carbon tubes consist of two or more graphite layers, are rolled up to form a seamless cylinder and are nested inside one another. Chiral and achiral arrangements of the carbon atoms in relation to the longitudinal axis of the carbon fibre are possible irrespective of the roll-up vector.

Structures of carbon tubes in which a single cohesive graphene layer (“scroll type”) or interrupted graphene layer (“onion (structure) type”), which is the basis for the construction of nanotubes, were described for the first time by Bacon et al., J. Appl. Phys. 34, 1960, 283-90. Corresponding structures were also discovered later by Zhou et al., Science, 263, 1994, 1744-47, and by Lavin et al., Carbon 40, 2002, 1123-30.

Carbon nanotubes (CNTs) are commercially available and are offered by different manufacturers (for example by Bayer MaterialScience AG, Germany, CNT Co. Ltd, China, Cheap Tubes Inc., USA, and Nanocyl S.A., Belgium). A person skilled in the art is familiar with the corresponding production methods. For example, carbon nanotubes (CNTs) can be produced by arc discharge, for example between carbon electrodes, starting from graphite by means of laser corrosion (“evaporation”), or by catalytic decomposition of hydrocarbons (chemical vapour deposition or CVD for short).

Depending on the detail of the structure, the electrical conductivity within the carbon nanotubes is metal or semiconductive. Carbon nanotubes are also known which are superconductive at low temperatures.

Transistors and simple circuits have already been produced using semiconductive carbon nanotubes. It has also already been attempted to produce complex circuits from different carbon nanotubes in a selective manner.

The mechanical properties of carbon nanotubes are outstanding: With a density of 1.3 to 1.4 g/cm³ for example, CNTs have an enormous tensile strength of several megapascals; by comparison, at a density of at least 7.8 g/cm³, steel has a maximum tensile strength of only approximately 2 MPa, from which it can be calculated that individual CNTs have a ratio of tensile strength to density which is at least 135 times better than that of steel.

Above all, the current carrying capacity, electrical conductivity and thermal conductivity are of interest in the field of electronics: The current carrying capacity is estimated to be 1000 times greater than that of copper wires, whilst thermal conductivity at room temperature is almost twice that of diamond. Since CNTs can also be semiconductors, they can be used to manufacture excellent transistors, which withstand higher voltages and temperatures, and therefore higher clock frequencies, compared to silicon transistors; functional transistors have already been produced from CNTs. Furthermore, non-volatile memories can be produced using CNTs. CNTs can also be used in the field of metrology (for example scanning tunnelling microscopes).

Due to their mechanical and electrical properties, carbon nanotubes can also be used in plastics: For example, the mechanical properties of the plastics can thus be improved considerably. It is also possible to produce electrically conductive plastics in this manner.

The properties of carbon nanotubes (CNTs) described previously and the growing possibilities for use as a result thereof have generated a great amount of interest.

In particular there is a need, for a range of applications, to provide carbon nanotubes (CNTs) in the form of “composite materials” by combining them with plastics or organic polymers.

There is thus no shortage of attempts in the prior art to produce composite materials based on plastics or organic polymers on the one hand, and carbon nanotubes (CNTs) on the other hand.

WO 2008/041965 A2 thus relates to a polymer composition which contains at least one organic polymer and carbon nanotubes (CNTs), the composite material in question being produced by introducing carbon nanotubes (CNTs) into a melt of the polymer with homogenisation. However, only low filling ratios can be achieved in this way, and therefore only insufficient electrical properties, in particular surface and volume resistances, are obtained. In addition, the mixture can only be homogenised insufficiently, and therefore a relatively inhomogeneous material is obtained.

Similarly, WO 2008/047022 A1 also relates to composite materials based on thermoplastic polymers and carbon nanotubes (CNTs), these composite materials likewise being obtained by introducing carbon nanotubes (CNTs) into a polymer melt, for example by means of injection moulding or extrusion methods, this being accompanied by the disadvantages described above.

C.-L. Yin et al., “Crystallization and morphology of iPP/MWCNT prepared by compounding iPP melt with MBCNT aqueous suspension”, Colloid. Polym. Sci., 2009, describe the compounding of isotactical polypropylene and multi-wall carbon nanotubes (MWCNTs) in the form of an aqueous suspension, wherein the filling ratios obtained are only very low and, in addition, no electrical properties of the resultant materials are described.

A. P. Kumar et al., “Nanoscale particles for polymer degradation and stabilization—Trans and future perspectives”, Progress in Polymer Science 34 (2009), 479-515 rather generally describe nanocomposites based on all types of polymers and nanoparticles. However, the article does not deal specifically with the problems of compounding of carbon nanotubes (CNTs) with polymers.

To summarise, the production of composite materials based on organic polymers and carbon nanotubes (CNTs) has not previously been solved satisfactorily in the prior art. In particular, the resultant composite materials only have insufficient filling ratios, generally combined with high inhomogeneities, and only insufficient electrical and mechanical properties.

### BRIEF SUMMARY OF THE INVENTION

The object of the present invention is therefore to provide a method for producing composite materials based on polymers or plastics on the one hand and carbon nanotubes (CNTs) on the other hand, and to provide the corresponding composite materials, wherein in particular the disadvantages described above associated with the prior art are avoided, at least in part, or are mitigated at the least.

In particular, an object of the present invention is to provide a method for producing composite materials which contain organic polymers or plastics and carbon nanotubes (CNTs), wherein the method can be better reproduced compared to the prior art and in particular makes it possible to achieve higher filling ratios of carbon nanotubes (CNTs) and/or improved homogeneity.

A further object of the present invention is to provide composite materials of the above-mentioned type based on organic polymers or plastics and carbon nanotubes (CNTs), in particular with increased filling ratios of carbon nanotubes (CNTs) and/or improved homogeneities and/or improved mechanical and/or electrical properties.

To solve the problem illustrated above, the present invention thus proposes a method according to the disclosure herein; providing further advantageous features of the method according to the invention.

The present invention further relates to composite materials obtainable by the method according to the invention, as described and defined in the corresponding claims directed to the composite materials; the respective dependent claims relate to further advantageous embodiments of the composite materials according to the invention.

Lastly, the present invention relates to the use of the composite materials obtainable by the method according to the invention, as described and defined in the corresponding use claims.

It is clear that specific configurations and embodiments which are described merely in conjunction with one aspect of the invention also apply accordingly to the other aspects of the invention, without this being mentioned expressly.

It should be noted that all relative amounts and percentages given hereinafter, in particular amounts based on weight, are to be selected and combined by a person skilled in the art, within the scope of the composition according to the invention, in such a way that the sum thereof, possibly with the inclusion of further components, ingredients, additives or constituents, in particular as described hereinafter, always adds up to 100% or 100% by weight. This is clear to a person skilled in the art, however.

In addition, depending on the application or individual circumstance, a person skilled in that art can deviate from the values, amounts and ranges disclosed hereinafter without departing from the scope of the present invention.

### BRIEF DESCRIPTION OF THE DRAWINGS

FIG. 1 shows a schematic view of the course of the method according to the invention in accordance with one particular practical example.

FIG. 2 shows a partly broken side view of an extruder which can be used within the scope of the invention;

FIG. 3 shows a vertical cross-section through the extruder with an arrangement of the retention degassing screw machine according to FIG. 2.

FIG. 4 shows a schematic view of a method for determining the surface resistance according to the invention.

### DETAILED DESCRIPTION OF THE INVENTION

According to a first aspect of the present invention, the present invention thus relates to a method for producing a composite material based on at least one polymer on the one hand and carbon nanotubes (CNTs) on the other hand, said method including the following method steps:
(a) providing a dispersion or solution of carbon nanotubes (CNTs) in a continuous, preferably liquid phase, in particular dispersing or solubilising carbon nanotubes (CNTs) in a continuous, preferably liquid phase, in particular in a dispersion medium or solvent; then
(b) introducing the dispersion or solution of carbon nanotubes (CNTs) produced in method step (a) into the melt of at least one polymer with homogenisation, in particular mixing, and with removal of the continuous liquid phase; then
(c) leaving to cool the mixture of molten polymer and carbon nanotubes (CNTs) obtained in method step (b) until the polymer has solidified to form a composite material which contains at least one polymer and carbon nanotubes (CNTs).

The applicant has surprisingly found that composite materials containing at least one organic polymer or an organic plastic on the one hand and carbon nanotubes (CNTs) on the other hand can be efficiently produced by means of the method described above.

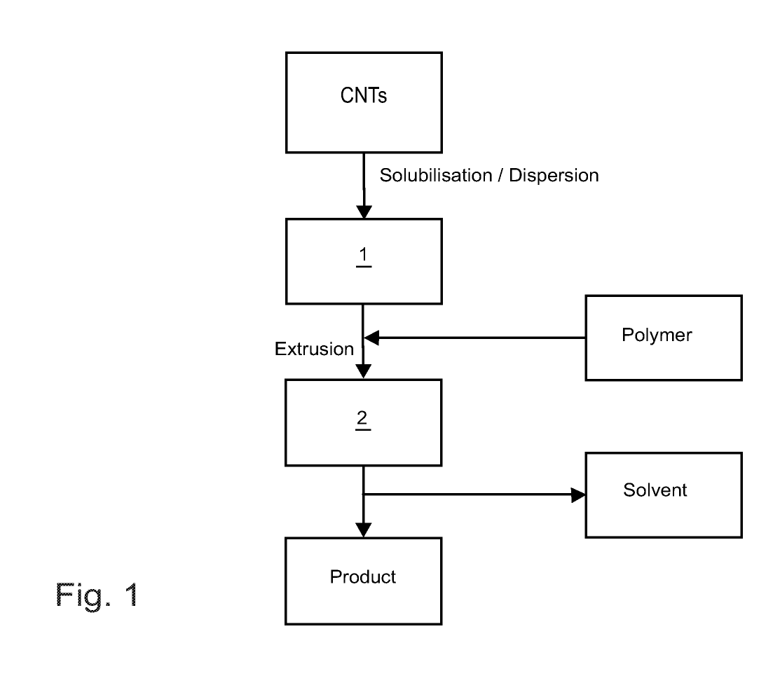

The course of the method according to the invention is illustrated by way of example in FIG. 1 in accordance with one embodiment.

In the figure:

FIG. 1 shows a schematic view of the course of the method according to the invention in accordance with one particular practical example.

FIG. 1 shows a schematic view of the course of the method according to the invention: In a first method step (a), carbon nanotubes (CNTs) are dispersed or solubilised in a continuous phase, which is generally liquid under the conditions of the method, in particular in a dispersion medium or solvent, so that a respective dispersion or solution of carbon nanotubes (CNTs) is obtained in the continuous, generally liquid phase (see 1 of FIG. 1). In a second method step (b), the previously produced dispersion or solution of carbon nanotubes (CNTs) is then introduced into the melt of at least one polymer or plastic with homogenisation, in particular mixing (see 2 of FIG. 1), followed by a removal of the continuous liquid phase (dispersion medium or solvent), which preferably occurs under extrusion conditions in a suitable extrusion apparatus, as will be described in greater detail hereinafter. Once the continuous, in particular liquid phase has been removed, in particular the dispersion medium or solvent, a mixture of molten polymer and carbon nanotubes (CNTs) is obtained which is left to cool in a subsequent method step (c) until the polymer has solidified. A composite material according to the invention which contains at least one generally organic polymer or a generally organic plastic on the one hand and carbon nanotubes (CNTs) on the other hand is obtained.

The expression “providing a dispersion or solution of carbon nanotubes (CNTs) in a continuous, preferably liquid phase” according to method step (a) of the method according to the invention also includes, however, the possibility of using suitable commercially available dispersions or solutions of carbon nanotubes (CNTs) in a continuous, preferably liquid phase, such as those sold by the Belgian company Nanocyl S.A., Sambreville, Belgium, or by FutureCarbon GmbH, Bayreuth, Germany.

The method according to the invention makes it possible to achieve particularly good homogenisation with regard to the distribution of the carbon nanotubes (CNTs) in the organic polymer or organic plastic since the carbon nanotubes (CNTs) are not introduced into the melt of the polymer in lump form, but in diluted form (namely in the form of a dispersion or solution). The method according to the invention also makes it possible to achieve relatively high filling ratios of carbon nanotubes (CNTs), which leads to improved electrical properties, in particular surface and volume resistances, of the obtained composite materials. Due to the aforementioned homogeneous, particularly uniform distribution, improved mechanical properties, such as bending strength, impact strength and other strengths of the resultant composite materials are likewise obtained. The method according to the invention can also be applied universally to a practically unlimited number of polymers and plastics.

The polymer used in accordance with the invention is generally a thermoplastic polymer. In particular, the polymer used in accordance with the invention is selected from the group of polyamides, polyacetates, polyketones, polyolefins, polycarbonates, polystyrenes, polyesters, polyethers, polysulfones, polyfluoropolymers, polyurethanes, polyamide imides, polyarylates, polyarylsulfones, polyethersulfones, polyarylsulfides, polyvinyl chlorides, polyether imides, polytetrafluoroethylenes, polyether ketones, polylactates, and mixtures and copolymers thereof.

The polymer used in accordance with the invention is preferably selected from thermoplastic polymers, preferably from the group of polyamides; polyolefins, in particular polyethylene and/or polypropylene; polyethylene terephthalates (PETs) and polybutylene terephthalates (PBTs); thermoplastic elastomers (TPEs), in particular olefin-based thermoplastic elastomers (TPE-Os or TPOs), cross-linked olefin-based thermoplastic elastomers (TPE-Vs or TPVs), urethane-based thermoplastic elastomers (TPE-Us or TPUs), thermoplastic copolyesters (TPE-Es or TPCs), thermoplastic styrene block copolymers (TPE-S or TPS), thermoplastic copolyamides (TPE-As or TPAs); thermoplastic acrylonitrile/butadiene/styrene (ABS); polylactates (PLAs); polymethyl(meth)acrylates (PMAs or PMMAs); polyphenylene sulfides (PPS); and mixtures and copolymers thereof.

The dispersion or solubilisation of carbon nanotubes (CNTs) in a continuous, in particular liquid phase is known per se to a person skilled in the art from the prior art. In this regard, reference can be made for example to the following documents, the entire relevant disclosure of which is hereby incorporated by reference: EP 1 359 121 A2, JP 2005-089738 A, JP 2007-169120 A, WO 2008/058589 A2 and the corresponding German equivalent (patent family member) DE 10 2006 055 106 A1, FR 2 899 573 A1 and US 2008/0076837 A1.

The dispersion or solution of the carbon nanotubes (CNTs) can normally be produced in method step (a) with energy input, in particular with an application of pressure and/or ultrasonic input.

The dispersion or solution can generally be produced in method step (a) by mixing in the liquid phase with an input of pressure, in particular by means of high-shear dispersion or by attrition, as will be described hereinafter in greater detail. Furthermore, the dispersion or solution can also be produced in method step (a) with ultrasonic input.

In particular, it has proven to be useful within the scope of the present invention if the dispersion or solubilisation of the carbon nanotubes (CNTs) carried out in method step (a) takes place in an attritor mill and/or with ultrasonic input, in particular with energy input, in particular of grinding energy, in the range of 5,000 to 50,000 kWh/t of solid (CNTs), preferably 5,000 to 20,000 kWh/t of solid (CNTs); apparatuses of this type are offered by Hosokawa Alpina AG, Augsburg, Germany, for example. Alternatively however, it is also possible to achieve the dispersion or solubilisation of carbon nanotubes (CNTs) carried out in method step (a) by means of high-shear dispersion. The aforementioned dispersion and solubilisation techniques make it possible to achieve maximum contents of solid (CNTs), in particular within short periods of time.

If the dispersion or solubilisation of the carbon nanotubes (CNTs) carried out in method step (a) takes place with high energy input, in particular in the manner described previously, particularly good end products can be obtained, in particular composite materials according to the invention having good to excellent electrical conductivity and, at the same time, good to excellent mechanical properties, such as good to excellent mechanical load bearing capacity.

Particularly good results, in particular composite materials according to the invention having good to excellent electrical conductivity and, at the same time, good to excellent mechanical properties, are obtained if the dispersion or solubilisation of the carbon nanotubes (CNTs) carried out in method step (a) is carried out in such a way that the resultant dispersion or solution has a low particle or agglomerate size of the carbon nanotubes (CNTs), wherein particle or agglomerate sizes of the carbon nanotubes (CNTs), determined as d90 value (for example determination by means of laser diffraction), of 100 μm at most, preferably 50 μm at most, more preferably 20 μm at most, even more preferably 10 μm at most, and yet even more preferably 5 μm at most are used or obtained in particular.

If the resultant dispersion or solution has a low particle of agglomerate size of the carbon nanotubes (CNTs), then this leads, during the subsequent incorporation into the polymer melt according to method step (b), to a particularly good distribution or homogenisation, that is to say good and homogeneous distribution of the CNTs in the polymer, and is therefore to be achieved in the end products, that is to say in the composite materials according to the invention, as a result of the prior dispersion or prior solubilisation of the CNTs in method step (a), in particular with particularly fine CNT dispersions or CNT solutions, as described previously. Better electrical conductivities at low(er) CNT concentrations and CNT load factors compared to the prior art, in particular compared to an introduction of CNTs in lump form or in agglomerate form (that is to say without prior dispersion) are achieved. As a result of the fine, in particular nanoparticle form of the introduced CNTs, improved mechanical properties are also obtained; the CNTs incorporated into the polymers are fine enough or small enough not to achieve normal filler effect. In particular, good dispersion can be achieved in accordance with the invention since the deagglomeration of the CNTs according to method step (a) occurs before the compounding carried out in method step (b), preferably in an attritor mill, and “only” homogeneous and fine distribution or incorporation of the CNT dispersion or CNT solution then has to be carried out or implemented in method step (b).

In method step (a), the carbon nanotubes (CNTs) are generally used in a concentration of 0.001 to 30% by weight, in particular 0.01 to 20% by weight, preferably 0.01 to 15% by weight, more preferably 0.01 to 10% by weight, in each case based on the resultant dispersion or solution.

Within the scope of the present invention, it has proven in particular to be advantageous if the dispersion or solution is produced in method step (a) by addition of the carbon nanotubes (CNTs) into the continuous liquid phase in steps or in batches; the individual batches may contain equal or different amounts of carbon nanotubes (CNTs). This approach in particular has the advantage that improved incorporation of the carbon nanotubes (CNTs) can be achieved, and in particular an excess intermediate increase in viscosity of the resultant dispersion or solution is avoided, which facilitates handling considerably.

In method step (a) the dispersion or solubilisation process is generally carried out in the presence of at least one additive, in particular of at least one dispersing or solubilising additive. Examples of additives of this type are dispersing agents (dispersants), in particular wetting agents or surfactants, antifoaming agents, stabilisers, pH adjusters, rheology modifiers or rheological additives, and additives improving compatibility, etc. as well as mixtures of the aforementioned type.

According to one particular embodiment of the present invention, method step (a) is carried out in the presence of at least one dispersing agent (dispersant). This has many advantages: On the one hand the dispersion or solubilisation behaviour of the carbon nanotubes (CNTs) can thus be improved significantly, in particular in terms of higher concentrations and shorter dispersion or solubilisation times. Homogeneity both of the dispersion or solution and of the subsequently produced composite material can also thus be controlled; without wanting to be tied to a specific theory in this regard, these effects may possibly be explained by the fact that the dispersing agent (dispersant) remains at least in part on the surface of the carbon nanotubes (CNTs) or adheres thereto or is bonded thereto so that the carbon nanotubes (CNTs) thus modified can be better incorporated into the polymer or plastic.

According to a particularly preferred embodiment of the present invention, wetting agents and surfactants are used as dispersing agents (dispersants) in accordance with the invention, particularly preferably from the group of copolymers of unsaturated 1,2 acid anhydrides modified by polyether groups, and from addition products of hydroxyl compounds and/or tertiary amino group-containing compounds of polyisocyanates.

Furthermore, even though less preferred in accordance with the invention, the dispersing agents (dispersants) used in accordance with the invention can also be selected from the group of polymers and copolymers containing functional and/or pigment affinic groups, alkyl ammonium salts of polymers and copolymers, polymers and copolymers containing acid groups, comb and block copolymers, such as block copolymers containing base pigment affinic groups in particular, optionally modified acrylate block copolymers, optionally modified polyurethanes, optionally modified and/or optionally salted polyamines, phosphoric acid esters, ethoxylates, polymers and copolymers containing fatty acid esters, optionally modified polyacrylates, such as transesterified polyacrylates, optionally modified polyesters, such as acid functional polyesters, derivatives of the cellulose, such as carboxymethyl cellulose, water-soluble sulfates or sulfonates of higher hydrocarbons, such as sodium dodecyl sulfonate, or of lower organic polymers, such as sulfonated polystyrene, water-dispersible pyrrolidones, such as polyvinyl pyrrolidone, polyphosphates, and mixtures thereof.

Dispersing agents (dispersants) preferred in accordance with the invention having number average molecular weights of at least 1,000 g/mol, preferably at least 2,000 g/mol, more preferably at least 3,000 g/mol, and most preferably at least 4,000 g/mol are used in particular; a tendency for migration in the end product (that is to say in the composite material) is reduced or even suppressed at least substantially completely with molecular weights of this type, in particular with increasing molecular weight.

If a dispersing agent (dispersant) is used in method step (a), this dispersing agent (dispersant) is preferably used in amounts of 10 to 300% by weight, preferably 50 to 250% by weight, in each case based on the carbon nanotubes (CNTs) to be dispersed or to be solubilised.

The expression “dispersing agent”—also referred to synonymously as a dispersant, dispersing additive, wetting agent, etc.—as used within the scope of the present invention generally denotes substances in particular which facilitate the dispersion of particles in a dispersion medium, in particular by lowering the interfacial tension between the two components (particles to be dispersed and dispersing agent), that is to by wetting. Consequently, a large number of synonymous names for dispersing agents (dispersants) are used, for example dispersing additive, settling preventative agent, wetting agent, detergent, suspension aid, dispersing aid, emulsifier, etc. The expression “dispersing agent” is not to be confused with the expression “dispersion medium”, because the latter denotes the continuous phase of the dispersion (that is to say the liquid, continuous dispersion medium). Within the scope of the present invention, the dispersing agent is also used to stabilise the dispersed particles (that is to say the carbon nanotubes), that is to say to keep them stable in dispersion and to efficiently avoid or at least minimise their reagglomeration; this in turn leads to the desired viscosities of the resultant dispersions, since easily handled, free-flowing systems are thus produced in practice, even at high concentrations of the dispersed carbon nanotubes.

For further details regarding the expressions “disperse phase”, “disperse”, “dispersing agent”, “disperse system” and “dispersion”, reference can be made for example to Römpp Chemielexikon, 10^{th} edition, Georg Thieme Verlag, Stuttgart/New York, Volume 2, 1997, pages 1014/1015 and to the literature referenced therein, the entire disclosure or content of which is hereby incorporated by reference.

According to one particular embodiment of the present invention, method step (a) is carried out in the presence of at least one antifoaming agent. The antifoaming agent can be used either as the only additive, or together with at least one further additive, in particular a dispersing agent (in particular as described previously). The antifoaming agent also contributes in a number of respects to a significant improvement to the dispersing or solubilising properties, but also with respect to the properties of the incorporation of the polymer and of the composite materials thus produced: On the one hand, the antifoaming agent effectively prevents foaming during the production process of the dispersion or solution within the scope of method step (a). On the other hand, the antifoaming agent also prevents an undesired foaming of the dispersion or solution of carbon nanotubes (CNTs) produced in method step (a) during introduction into the melt of the polymer or plastic, since this introduction normally occurs at high pressures. Furthermore, the antifoaming agent also prevents an undesired foaming of the polymer, in particular during introduction of the dispersion or solution of carbon nanotubes (CNTs), which consequently also leads to improved properties in the end product, that is to say the resultant composite material.

Antifoaming agents preferably used in accordance with the invention are selected in particular from the group of mineral oil-based or silicone-based antifoaming agents and mixtures or combinations thereof.

The amount of antifoaming agent used in method step (a) can vary widely. Amounts of 0.1 to 300% by weight, in particular 0.5 to 150% by weight, preferably 5 to 200% by weight, more preferably 10 to 150% by weight, and particularly preferably 20 to 100% by weight of antifoaming agent are generally used in method step (a), in each case based on the carbon nanotubes (CNTs). In accordance with the invention, the antifoaming agent is furthermore generally used in amounts of 0.01 to 20% by weight, in particular 0.02 to 10% by weight, preferably 0.03 to 5% by weight, more preferably 0.05 to 2% by weight, and particularly preferably 0.05 to 1% by weight, in each case based on the resultant dispersion or solution.

With regard to the continuous, generally liquid phase used in method step (a), in particular the solvent or dispersion medium used in method step (a), this can be an aqueous, an organic or an aqueous-organic solvent or dispersion medium. A solvent or dispersion medium present in the liquid aggregate state under dispersion or solubilisation conditions, in particular at atmospheric pressure (101.325 kPa) and in a temperature range of 10 to 100° C., preferably 25 to 70° C. is generally used as a continuous liquid phase in method step (a). Reference can be made in this regard to the prior art mentioned previously in conjunction with the production of the dispersion or solution of carbon nanotubes (CNTs).

With regard to the continuous phase, in particular the solvent or dispersion medium, this is generally selected in such a way that it has a boiling point at atmospheric pressure (101.325 kPa) in a temperature range of 20 to 300° C., preferably 50 to 200° C., more preferably 60 to 150° C.

The dispersion or solution of carbon nanotubes (CNTs) produced in method step (a) can generally advantageously be introduced by means of a feed pump and/or metering pump. The introduction is normally carried out with an application of pressure, in particular at a feed pressure of 2 to 100 bar, preferably 5 to 50 bar, preferably 10 to bar, since the dispersion or solution of carbon nanotubes (CNTs) is introduced into the molten polymer such that the steam pressure of the continuous liquid phase has to be counteracted. The introduction is advantageously implemented at constant metering rate and/or at constant metering accuracy so that a constant, uniform introduction into the molten polymer is ensured, and an end product of persistently uniform, homogeneous quality is thus obtained.

Feed pumps and/or metering pumps which are suitable in accordance with the invention are sold for example by ViscoTec Pumpen and Dosiertechnik GmbH, Toging/Inn, Germany.

The CNT dispersion or CNT solution is introduced or metered directly into the polymer melt against the pressure of the melt for immediate or instantaneous dispersion in the polymer without the possibility of agglomerate formation.

The CNT suspension or CNT solution is normally metered or introduced into or placed in the polymer melt in liquid phase; attention should be paid in particular to the steam pressure. Particularly good results are obtained due to this approach.

With regard to the implementation of method step (b), in particular the introduction of the dispersion or solution of carbon nanotubes (CNTs) produced in method step (a) into the melt of at least one polymer, this method step or this introduction is advantageously carried out in an extrusion apparatus. In accordance with a preferred embodiment, the extrusion apparatus is designed is a screw-type extruder.

The polymer is advantageously heated to at least 10° C., preferably at least 20° C., particularly preferably 10 to 50° C. above its melting point or melting range. It is thus reliably ensured that all polymer is present in the molten state. Temperatures of 150° C. to 300° C., in particular 180° C. to 280° C. are normally applied for the polymers used in accordance with the invention, that is to say the polymers are normally heated to temperatures of 150° C. to 300° C., in particular 180° C. to 280° C., in method step (b). By contrast, excessively high temperatures may lead to partial decomposition or partial breakdown of the polymers and any additives present, whereas at excessively low temperatures there is a risk that the melt will be inhomogeneous or that at least some of the polymer will not be melted.

According to a particular embodiment, the extrusion apparatus may comprise mixing means for homogenising, in particular for mixing thoroughly, the dispersion or solution of carbon nanotubes (CNTs) produced in method step (a) with the melt of at least one polymer, and/or may comprise a degassing device, preferably for degassing at reduced pressure, for the purposes of removing the continuous liquid phase.

According to one particular embodiment, the extrusion apparatus can be divided into a plurality of sections or zones. The extrusion apparatus may have a first section or a first zone for introduction of the at least one polymer, followed by a melt section (melt zone) for melting the polymer, then followed by a feed section (feed zone) for feeding the dispersion or solution of carbon nanotubes (CNTs), then followed by a homogenisation and degassing section (homogenisation and degassing zone), which then joins to a discharge section (discharge zone).

Particularly good results, in particular composite materials according to the invention having good to excellent electrical conductivity and, at the same time, good to excellent mechanical properties, are obtained if the dispersion or solution of CNTs produced previously in method step (a) is introduced in method step (b) at high rotary speed of the extruder, in particular of the feed screw of the extruder, and/or at low throughput and/or high energy consumption. Particularly fine CNT dispersions or CNT solutions, as defined previously, are used in particular. The CNT dispersion or CNT solution is preferably introduced in method step (b) at a volume-based throughput of 1 to 1,000 ml/min, in particular 2 to 500 ml/min, preferably 5 to 200 ml/min, preferably 10 to 100 ml/min. Rotary speeds of the extruder, in particular of the feed screw of the extruder, in the range of 100 to 1,000 rpm, in particular 200 to 900 rpm, preferably 300 to 800 rpm, are preferred in accordance with the invention. Mass-based throughputs of the polymer in the range of 0.1 to 100 kg/h, in particular 1 to 50 kg/h, preferably 2 to 25 kg/h, preferably 3 to 15 kg/h are furthermore advantageous in accordance with the invention.

The continuous phase of the CNT dispersion or CNT solution (for example water and/or organic solvent, etc.) is simultaneously removed within the scope of method step (b). Residual amounts of continuous phase, in particular residual amounts of water, of 2% by weight at most, in particular 1% by weight at most, preferably 0.5% by weight at most, more preferably 0.3% by weight at most, most preferably 0.2% by weight at most, based on the end product (that is to say based on the composite material according to the invention) are preferably obtained or set. Particularly good results are obtained if the continuous phase of the CNT dispersion or CNT solution is removed in a number of stages, in particular in at least two stages, preferably in an extrusion apparatus, wherein the extrusion apparatus may comprise the corresponding discharging or degassing means for discharging or draining the continuous phase, generally in gaseous form due to the temperatures applied, as will be described hereinafter in greater detail.

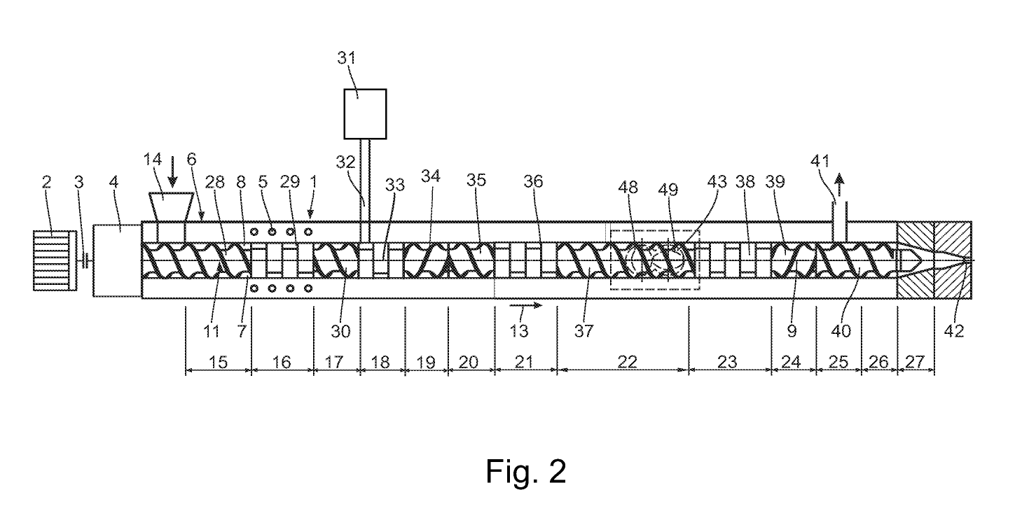

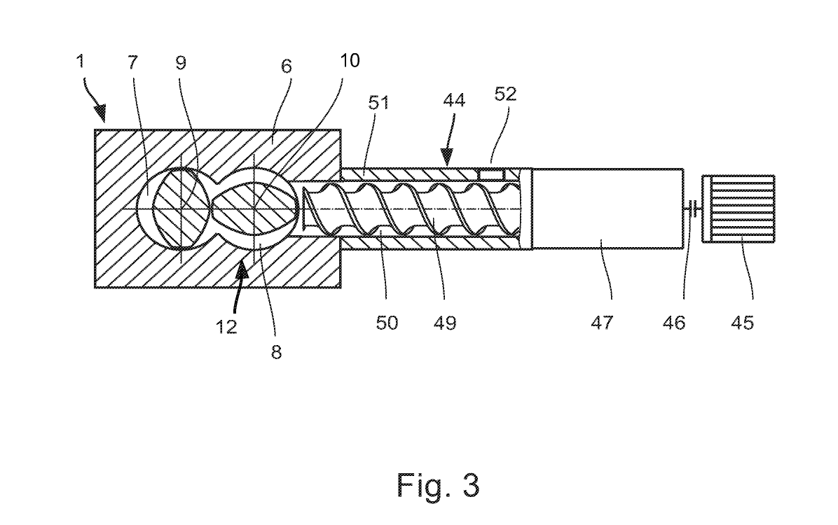

An exemplary embodiment of an extrusion apparatus preferably used in accordance with the invention is shown in the illustrations according to FIGS. 2 and 3, in which:

FIG. 2 shows a partly broken side view of an extruder which can be used within the scope of the invention;

FIG. 3 shows a vertical cross-section through the extruder with an arrangement of the retention degassing screw machine according to FIG. 2.

The exemplary embodiment illustrated in the drawing according to FIGS. 2 and 3 comprises an extruder 1. It is driven by means of a motor 2 via a coupling 3 and a transmission 4. The extruder 1 comprises a housing 6 provided with a heater 5, two housing bores 7, 8 engaging in one another approximately in the form of a figure of eight and having mutually parallel axes 9, 10 being formed in said housing. Two screw shafts 11, 12 are arranged in these housing bores 7, 8 and are coupled to the transmission 4. The screw shafts 11, 12 are driven in the same direction. The extruder 1 comprises a feed hopper 14 arranged after the transmission 4 in a direction of feed 13, wherein plastic(s) (polymer(s)) to be processed is/are fed through said feed hopper and a catchment zone 15 joins on from said feed hopper. A melt zone 16 joins on from said catchment zone. A feed zone 17 joins on from said melt zone 16. The filler mixing zone 18 is formed subsequently. The back-up zone 19 is arranged downstream thereof. The feed zone 20 and the homogenisation zone 21 follow. A vacuum degassing zone 22 is formed subsequently, to which a mixing zone 23 joins on. A back-up zone 24 follows this mixing zone 23, a vacuum degassing zone 25 being located afterwards. A pressure build-up zone 26 joins onto this, followed by a discharge zone 27.

The screw shafts 11, 12 comprise screw elements 28 in the catchment zone 15. They are provided with kneading elements 29 in the melt zone 16. Screw elements 30 are again arranged in the feed zone 17. Mixing elements 33, as are already known from DE 41 34 026 C2 (corresponding to U.S. Pat. No. 5,318,358 A), are provided in the filler mixing zone 18. In addition, a dispersion or solution of carbon nanotubes and optionally of additives is guided via a suspension metering device 31 into the housing bore in a continuous liquid phase via the feed line 32.

Accumulation elements 34 in the form of return screw elements or the like are provided in the back-up zone 19. Screw elements 35 are arranged in the feed zone 20, and mixing elements are arranged in the homogenisation zone 21.

Screw elements 37 are provided in the vacuum degassing zone 22, and kneading elements 38 are provided in the mixing zone 23.

Damming elements 39 are again provided in the back-up zone 24. Screw elements 40 are again provided in the vacuum degassing zone 25, the subsequent pressure build-up zone 26 and the discharge zone 27. A nozzle 42 is connected to the pressure build-up zone 26 and to the discharge zone 27.

The molten plastic (polymer) is degassed under vacuum in the vacuum degassing zone 25 via a connecting line 41.

In the vacuum degassing zone 22, a retention degassing screw machine 43 leads out into a housing bore 7, radially to the axis 9. It comprises a drive motor 45, which is coupled via a coupling 46 to a transmission 47, which drives two tightly intercombed feed screws 48, 49 in the same direction. The feed screws 48, 49 are arranged in housing bores 50, which likewise penetrate one another in the form of a figure of eight, and lead into the housing bore 7 through a retention degassing opening 43 in the housing 6 and reach as far as the vicinity of the screw elements 37.

The molten plastic is retained in the retention degassing screw machine 43 by the screws driven in the same direction, and is degassed in the housing 51 against atmospheric pressure via a degassing opening 52.

The plastic (polymer) melted in the melt zone 16 completely fills the cross-section of the screw, at least in the filler mixing zone 18, by means of the accumulation elements 34. The rotary speed of the extruder is selected in such a way that the pressure in the mixing zone 18 is above the steam pressure, for example above 20 bar in the case of polyethylene (PE) or polypropylene (PP) at a temperature of 200° C.

The metering device 31 for the dispersion or solution is to be designed in such a way that it can overcome pressure prevailing in the mixing zone 18 when the suspension is metered.

In practice, it has proven to be expedient to select the diameter of the feed line 32 to be greater than 4 mm so as to prevent blockages of the feed lines.

The molten plastic (polymer) mixed with dispersion (that is to say solvent or dispersion medium, carbon nanotubes and optional additives) reaches the feed zone 20 after the back-up zone 19. From here, the pressure in the extruder reduces, and the fractions of solvent or dispersion medium (for example water fractions of the dispersion or solution) evaporate and are removed via the retention degassing opening 43 in the retention degassing screw machine 43. The rotary speed of the retention degassing screw machine 43 is selected in such a way that the molten plastic (polymer) is retained in an operationally reliable manner.

Mechanical energy is introduced into the plastic melt in the mixing zone 23 by means of the kneading element 38 so as to prevent an excessively rapid cooling of the plastic melt as a result of the enthalpy of condensation.

Any residues of moisture and any solvent still remaining are then removed in the vacuum degassing zone 25 via the connecting line 41.

Extrusion apparatuses which are suitable in accordance with the invention are sold for example by Coperion GmbH (formerly Coperion Werner & Pfleiderer GmbH & Co. KG), Stuttgart, Germany.

The method according to the invention can generally be carried out continuously or semi-continuously. In particular, method step (a) can be carried out discontinuously, and subsequent method steps (b) and (b) can be carried out continuously.

Within the scope of the present invention, the carbon nanotubes (CNTs) can be incorporated into the polymer or plastic at high concentrations or high filling ratios. The carbon nanotubes (CNTs) can generally be incorporated in amounts of 0.001 to 20% by weight, in particular 0.1 to 15% by weight, preferably 0.5 to 12% by weight, more preferably 1 to 10% by weight, based on the composite material formed of polymer and carbon nanotubes (CNTs).

With regard to the carbon nanotubes (CNTs) used within the scope of the method according to the invention, the following can be mentioned.

Practically any carbon nanotubes (CNTs), as can be produced by methods known from the prior art or as can be obtained as commercially available products (for example from Bayer MaterialScience AG, Leverkusen), can be used within the scope of the method according to the invention.

For example, the carbon nanotubes (CNTs) used in accordance with the invention can be single-wall carbon nanotubes (SWCNTs or SWNTs) or multi-wall carbon nanotubes (MWCNTs or MCNTs), in particular 2- to 30-wall, preferably 3- to 15-wall carbon nanotubes.

The carbon nanotubes (CNTs) used in accordance with the invention may have mean inner diameters of 0.4 to 50 nm, in particular 1 to 10 nm, preferably 2 to 6 nm, and/or mean outer diameters of 1 to 60 nm, in particular 5 to 30 nm, preferably 10 to 20 nm. The carbon nanotubes (CNTs) used in accordance with the invention may have mean lengths of 0.01 to 1,000 μm, in particular 0.1 to 500 μm, preferably 0.5 to 200 μm, more preferably 1 to 100 μm.

The carbon nanotubes (CNTs) used in accordance with the invention may further have a tensile strength per carbon nanotube of at least 1 GPa, in particular at least 5 GPa, preferably at least 10 GPa, and/or a modulus of elasticity per carbon nanotube of at least 0.1 TPa, in particular at least 0.5 TPa, preferably at least 1 TPa, and/or a thermal conductivity of at least 500 W/mK, in particular at least 1,000 W/mK, preferably at least 2,000 W/mK, and/or an electrical conductivity of at least 10³S/cm, in particular at least 0.5·10⁴ S/cm, preferably at least 10⁴ S/cm.

Carbon nanotubes (CNTs) which are normally used have a bulk density in the range of 0.01 to 0.3 g/cm³, in particular 0.02 to 0.2 g/cm³, preferably 0.1 to 0.2 g/cm³, and are present in the form of agglomerates or conglomerates of a multiplicity of carbon nanotubes (CNTs), in particular in highly clumped form.

Carbon nanotubes (CNTs) which are suitable in accordance with the invention are commercially available, for example via Bayer MaterialScience AG, Leverkusen, for example the product range Baytubes® (for example Baytubes® C 150 P).

In principle, the carbon nanotubes used may be of the cylinder type, the scroll type or the type having an onion-like structure for example, and are in each case single-wall or multi-wall, preferably multi-wall.

According to a preferred embodiment, the carbon nanotubes (CNTs) used may have a ratio of length to outer diameter of ≧5, preferably of ≧100.

According to one particular embodiment, the carbon nanotubes (CNTs) can be used in the form of agglomerates; the agglomerates may have a mean diameter in particular in the range of 0.05 to 5 mm, preferably 0.1 to 2 mm, more preferably 0.2 to 1 mm.

According to another particular embodiment, the carbon nanotubes (CNTs) used may have a mean diameter of 3 to 100 nm, preferably 5 to 80 nm, more preferably 6 to 60 nm.

For example, the carbon nanotubes (CNTs) of the scroll type having a plurality of graphene layers, which are combined to form a stack or are rolled up, may be selected. Products of this type are available for example from Bayer MaterialScience AG, Leverkusen, for example the product range Baytubes® (for example Baytubes® C 150 P).

As described previously, any single-wall or multi-wall carbon nanotubes, for example of the cylinder type, scroll type or with an onion-like structure, can be used in particular as carbon nanotubes within the meaning of the invention. Multi-wall carbon nanotubes of the cylinder type, scroll-type, or mixtures thereof are preferred.

As described previously, carbon nanotubes having a ratio of length to outer diameter of greater than 5, preferably greater than 100 are particularly preferably used.

As described previously, the carbon nanotubes are particularly preferably used in the form of agglomerates, wherein the agglomerates in particular have a mean diameter in the range of 0.05 to 5 mm, preferably 0.1 to 2 mm, more preferably 0.2 to 1 mm.

Carbon nanotubes which can be used in accordance with the invention particularly preferably basically have a mean diameter of 3 to 100 nm, preferably 5 to 80 nm, more preferably 6 to 60 nm.

In contrast to the known CNTs of the scroll type mentioned at the outset having only one continuous or interrupted graphene layer, CNT structures which consist of a plurality of graphene layers, which are combined to form a stack and are rolled up (“multi-scroll type”) are also used in accordance with the invention. These carbon nanotubes and carbon nanotube agglomerates thereof are the object of DE 10 2007 044 031 and US 2009/0124705 A1 for example, the respective content of which with regard to CNTs and production thereof is hereby included in the disclosure of the present application. This CNT structure behaves comparatively to the carbon nanotubes of the simple scroll type, just as the structure of multi-wall cylindrical carbon nanotubes (cylindrical MWNTs) behaves comparatively to the structure of single-wall cylindrical carbon nanotubes (cylindrical SWNTs).

In contrast to the onion-type structures, in these carbon nanotubes the individual grapheme or graphite layers, viewed in cross-section, clearly extend continuously from the centre of the CNTs to the outer edge, without interruption. For example, this may enable improved and quicker intercalation of other materials in the tube framework, since more open edges are available as inlet zones of the intercalates compared to CNTs of simple scroll structure (Carbon 34, 1996, 1301-3) or CNTs of onion-type structure (Science 263, 1994, 1744-7).

The methods known today for the production of carbon nanotubes include arc discharge, laser ablation and catalytic methods in particular. Soot, amorphous carbon and fibres of high diameter are formed as by-products in many of these methods. With regard to the catalytic methods, a distinction can be made between deposition on supported catalyst particles and deposition on metal centres formed in situ having diameters in the nanometre range (“flow methods”). In the case of production by catalytic deposition of carbon from hydrocarbons which are gaseous under reaction conditions (also referred to hereinafter as “CCVD” or catalytic carbon vapour deposition), acetylene, methane, ethane, ethylene, butane, butene, butadiene, benzene or other carbonaceous starting materials are used as possible carbon donors. CNTs obtainable from catalytic methods are therefore preferably used in accordance with the invention.

The catalysts generally contain metals, metal oxides or decomposable or reducible metal components. For example, Fe, Mo, Ni, V, Mn, Sn, Co, Cu and further secondary group elements are cited in the prior art as metals for the catalyst. The individual metals indeed usually have a tendency to assist the formation of carbon nanotubes, but according to the prior art high yields and low fractions of amorphous carbons are advantageously achieved with metal catalysts which are based on a combination of the above-mentioned metals. CNTs obtainable with use of mixed catalysts are consequently preferably used in accordance with the invention.

Particularly advantageous catalyst systems for the production of CNTs are based on combinations of metals or metal compounds which contain two or more elements from the group Fe, Co, Mn, Mo and Ni.

The formation of carbon nanotubes and the properties of the carbon nanotubes formed generally depend, in a complex manner, on the metal components or on a combination of a plurality of metal components used as a catalyst, on the catalyst carrier material used optionally, and on the interaction between catalyst and carrier, on the starting material gas and partial pressure, and admixture of hydrogen or further gases, on the reaction temperature, and on the residence time and reactor used.

A particularly preferred method to be used to produce carbon nanotubes is known from WO 2006/050903 A2.

Carbon nanotubes of different structure which can be removed from the process predominantly as carbon nanotube powder are produced in the different methods cited herein with use of different catalyst systems.

Suitable carbon nanotubes which are further preferred for the invention are obtained by methods which are described in principle in the literature below:

The production of carbon nanotubes having diameters of less than 100 nm was first described in EP 0 205 556 B1. Light (that is to say short- and medium-chain aliphatic or single- or two-core aromatic) hydrocarbons and an iron-based catalyst are used for the production process, in which carbon carrier bonds are destroyed at a temperature above 800 to 900° C.

WO 86/03455 A1 describes the production of carbon filaments which have a cylindrical structure having a constant diameter of 3.5 to 70 nm, an aspect ratio (that is to say a ratio of length to diameter) of greater than 100 and a core region. These fibrils consist of many continuous layers or ordered carbon atoms, which are arranged concentrically about the cylindrical axis of the fibrils. These cylindrical nanotubes were produced from carbonaceous compounds by a CVD process by means of a metal-containing particle at a temperature between 850° C. and 1200° C.

A method for producing a catalyst is also known from WO 2007/093337 A2 and is suitable for the production of conventional carbon nanotubes of cylindrical structure. Higher yields of cylindrical carbon nanotubes having a diameter in the range of 5 to 30 nm are obtained with use of this catalyst in a packed bed.

A completely different way of producing cylindrical carbon nanotubes was described by Oberlin, Endo and Koyam (Carbon 14, 1976, 133). Aromatic hydrocarbons, such as benzene, are reacted with a metal catalyst. The carbon tubes produced exhibit a well-defined, hollow graphite core which has approximately the diameter of the catalyst particle and on which further carbon is located which is ordered in manner less like graphite. The whole tube can be graphitised by treatment at high temperature (approximately 2,500° C. to 3,000° C.).

Most of the previously mentioned methods (by arc discharge, spray pyrolysis and CVD, etc.) are now used for the production of carbon nanotubes. However, the production of single-wall cylindrical carbon nanotubes is very complex and progresses at a very slow rate of formation in accordance with the known methods and often also with many side reactions, which lead to a high fraction of undesired impurities, that is to say the yields of such methods is comparatively low. The production of carbon nanotubes of this type is therefore also still extremely technically complex, and they are therefore used above all in small amounts for highly specialised applications. They are suitable for use in the invention, but the use of multi-wall CNTs of the cylinder or scroll type is more preferred.

Multi-wall carbon nanotubes are now produced commercially in larger amounts in the form of seamless cylindrical nanotubes nested in one another or else in the form of the described scroll or onion-like structures, predominantly with use of catalytic methods. These methods normally demonstrate a greater yield than the above-mentioned arc discharge and other methods, and are typically carried out nowadays on a scale of kilograms (a few hundred kilograms per day worldwide). The MW carbon nanotubes thus produced are generally somewhat more cost-effective than single-wall nanotubes and are therefore used for example in other substances as a performance-increasing additive.

According to a second aspect of the present invention, the present invention further relates to composite materials which contain at least one polymer on the one hand and carbon nanotubes (CNTs) on the other hand, in particular as are obtainable by the previously described method according to the invention.

In particular, the present invention relates to composite materials which contain at least one polymer on the one hand and carbon nanotubes (CNTs) on the other hand, in particular as are obtainable by the previously described method according to the present invention, wherein the composite materials according to the invention generally have a content of carbon nanotubes (CNTs) of 0.001 to 20% by weight, in particular 0.1 to 15% by weight, preferably 0.5 to 12% by weight, more preferably 1 to 10% by weight, based on the composite material.

Due to the production process in particular, the composite materials according to the invention may furthermore contain at least one dispersing agent (dispersant), in particular as defined previously, preferably in amounts of 0.01 to 300% by weight, in particular in amounts of 0.05 to 250% by weight, preferably 0.1 to 200% by weight, more preferably 0.5 to 150% by weight, and most preferably 1 to 100% by weight, in each case based on the carbon nanotubes (CNTs). The dispersing agent enables a good and particularly homogeneous incorporation of the carbon nanotubes (CNTs) over the course of the production process.

Furthermore, in particular likewise due to the production process, the composite materials according to the invention may contain at least one antifoaming agent, in particular as defined previously, preferably in amounts of 0.01 to 200% by weight, in particular 0.05 to 175% by weight, preferably 0.1 to 150% by weight, and more preferably 0.2 to 100% by weight, in each case based on the carbon nanotubes (CNTs). Similarly to the dispersing agent, the antifoaming agent also ensures a good and homogeneous incorporation of the carbon nanotubes (CNTs) over the course of the production process.

Furthermore, the composite materials according to the invention have excellent electrical and conductivity properties.

In particular, the composite materials according to the invention have excellent electrical resistance values. The electrical resistance of an insulator between any two electrodes on or in a test specimen of any form is called an insulating resistance, a distinction being made between three different types of resistance, namely volume resistance/volume resistivity, surface resistance/surface resistivity, and insulation resistance. Volume resistance is understood to mean the resistance inside materials measured between two planar electrodes, in particular as determined by DIN IEC 60 093 VDE 0303/30; if the volume resistance is converted to a cube measuring 1 cm³, the volume resistivity is obtained. By contrast, the surface resistance provides information on the insulation state at the surface of an insulator, in particular likewise determined by DIN IEC 60 093 VDE 0303/30. Reference can be made for example to Schwarz/Ebeling (Hrsg.), Kunststoffkunde, 9^{th} edition, Vogel Buchverlag, Würzburg, 2007, in particular to chapter 6.4 “Electrical Properties” for further details in this regard.

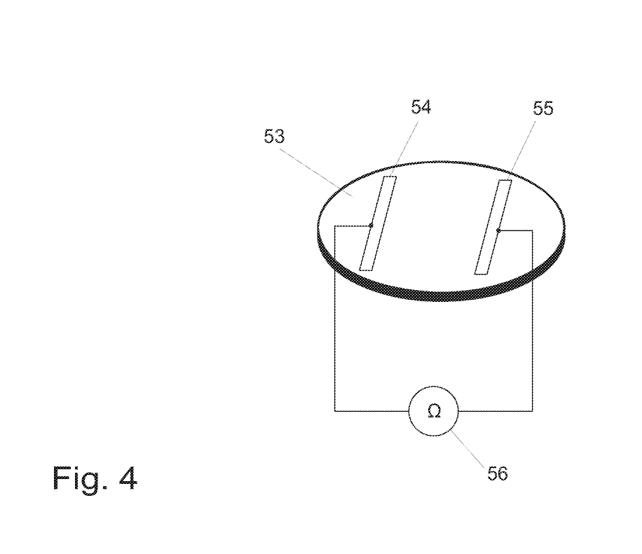

Alternatively, the surface resistance can also be determined by a method as illustrated schematically in FIG. 4 and also in the practical examples: The electrical surface resistance is measured by this method, as illustrated in FIG. 4, on sample specimens having a diameter of 80 mm and a thickness of 2 mm, produced by a pressing method. For the different polymers as used in the practical examples, the following temperatures for example are used for the production of the pressed plates: polypropylene 200° C.; polyethylene 220° C.; polyamide 280° C. As shown in FIG. 4, two conductive silver strips 23, 24 are applied to the circular test specimen 22, the length B of said strips coinciding with the spacing L thereof so that a square area sq is defined. The electrodes of an ohmmeter 25 are then pressed onto the conductive silver strips 23, 24, and the resistance value is read at the ohmmeter 25. A measurement voltage of 9 volts is used at resistances up to 3×10⁷ ohm/sq, and of 100 volts from 3×10⁷ ohm/sq.

In particular, the composite materials according to the invention thus have a surface resistance, in particular a surface resistivity, of less than 10⁸ ohm, in particular less than 10⁷ ohm, preferably less than 10⁶ ohm, preferably less than 10⁵ ohm, more preferably less than 10⁴ ohm, most preferably less than 10³ ohm.

Furthermore, the composite materials according to the invention in particular have a volume resistance, in particular a volume resistivity, of less than 10¹² ohm·cm, in particular less than 10¹¹ ohm·cm, preferably less than 10¹⁰ ohm·cm, preferably less than 10⁹ ohm·cm, more preferably less than 10⁸ ohm·cm, most preferably less than 10⁷ ohm·cm.

In addition, the composite materials according to the invention have excellent mechanical properties, in particular such as excellent impact strength, yield strain and elongation at failure, yield stress, tensile modulus, etc.

According to a third aspect of the present invention, the present invention lastly also relates to the use of the previously described composite materials according to the present invention in the field of electronics and electrical engineering, computer and semiconductor engineering and industries, metrology and the associated industry, aeronautical and aerospace engineering, the packing industry, the automotive industry and cooling technology.

In particular, the previously described composite materials can be used for the production of conductive or semiconductive component parts, components, structures, apparatuses or the like, in particular for the field of electronics and electrical engineering, computer and semiconductor engineering and industries, metrology and the associated industry, aeronautical and aerospace engineering, the packing industry, the automotive industry and cooling technology.

The present invention, in particular the method according to the invention the composite materials obtainable in this manner, are associated with a large number of particular features and advantageous properties which distinguish the invention with respect to the prior art:

Within the scope of the present invention, carbon nanotubes (CNTs) can be incorporated into organic polymers and plastics in a reliable and reproduced manner.

Within the scope of the invention, composite materials are produced which are based on organic polymers or plastics on the one hand and on carbon nanotubes (CNTs) on the other hand, and which have relatively high filling ratios or concentrations of carbon nanotubes (CNTs) and improved homogeneity, which likewise leads to an improvement of the electrical and mechanical properties. In particular, the composite materials according to the invention have improved surface and volume resistances compared to the prior art as well as improved mechanical resistance.

Within the scope of the method according to the invention, carbon nanotubes (CNTs) can be incorporated into the aforementioned polymers and plastics at high concentrations, exact metering accuracies, high throughputs and with excellent homogeneities.

Solvent- and/or water-sensitive polymers can also be reacted within the scope of the present invention. For example, it is to be stressed in the case of polyamides that, although they are water-sensitive polymers which generally tend towards hydrolytic degradation in the presence of water during the compounding process according to the prior art, they can be readily processed and used within the scope of the method according to the invention (even in the presence of water), it even being possible to introduce an aqueous CNT suspension in order to produce a corresponding composite material; there is no hydrolytic degradation of the polymer, in particular since there is only very brief loading with water, what's more at high pressure.

Generally, very small or practically no residual moisture is achieved in the end products in accordance with the invention, which is unexpected when compounding large amounts of water.

Further embodiments, modifications and variations of the present invention are readily identifiable and achievable by a person skilled in the art upon reading the description, without departing from the scope of the present invention.

The present invention will be illustrated with the aid of the practical examples below, which are not intended to limit the present invention, however.

### PRACTICAL EXAMPLES

### General Test Execution

Aqueous dispersions of carbon nanotubes of varying concentrations were produced in the presence of dispersing additives (dispersing agents or wetting agents as well as antifoaming agents) using an attritor mill by Hosokawa Alpine AG, Augsburg, Germany, said carbon nanotube dispersions then being introduced by means of a metering/feed pump by ViscoTec Pumpen and Dosiertechnik GmbH, Toging/Inn, Germany into an extrusion apparatus (Coperion GmbH, formerly: Coperion Werner & Pfleiderer GmbH & Co. KG, Stuttgart, Germany) together with molten polymer with homogenisation or mixing and with removal of the continuous liquid phase (water). After extrusion and once the mixture of molten polymer and carbon nanotubes (CNTs) thus obtained had been left to cool until the polymer had solidified, composite materials according to the invention based on polymer and carbon nanotubes (CNTs) were obtained.

### Production of Dispersing Agents (Dispersants) which can be Used in Accordance with the Invention

### Production Example 1

### Example 3 According to EP 0 154 678 A1

7.7 parts of an aliphatic hexamethylene diisocyanate-based polyisocyanate of the Biuret type having a free NCO content of 22% were homogenised under a protective atmosphere with parts of ethyl glycol acetate and 10.2 parts of a monohydroxy functional methoxypolyethylene glycol having a number average molecular weight Mn of 750, dissolved in 15 parts of ethyl glycol acetate, 0.004 parts of dibutyl tin dilaurate were added and the reaction mixture was heated to 50° C. Once a third of the NCO groups had reacted, 5.4 parts of polyethylene glycol having a number average molecular weight Mn of 800 and dissolved in 15 parts of ethyl glycol acetate were added. Once 66% of the NCO groups introduced had reacted, the reaction mixture was diluted with 23 parts of ethyl glycol acetate, and 1.7 parts of 1-(2-aminoethyl)piperazine were added. The reaction mixture was stirred at 70° C. for two hours. The product is yellowish and slightly viscous.

### Production Example 2

### Example According to EP 1 640 389

Example for a dispersing agent which is based on a copolymer of unsaturated 1,2-acid anhydrides modified by polyether groups and which can be used in accordance with the invention: A mixture of 80 g of conjugated sunflower fatty acid, 37 g of maleic anhydride, and 42 g of polyoxyethylene allylmethylether having an average molecular weight of 450 were provided and heated to 137° C. with stirring. A solution of 4.4 g of tert-butylperbenzoate in 53 g of dipropylene glycoldimethylether was added dropwise within a period of four hours. Once the addition was complete, the reaction mixture was stirred at 137° C. for a further 0.5 hours. The product obtained had a solid content of 75%. 91 g of this product were mixed with 84 g of a primary monoaminalcoxylate having an EO/PO ratio of 70/30 and an average molecular weight of 2,000, and with 0.2 g of para-toluene sulfonic acid, and the reaction mixture was stirred at 170° C. for three hours. A water separator was then installed and the reaction water was distilled off for three hours at 170° C. The product obtained has an amine number of <1 mg KOH/g and an acid number of 46 mg KOH/g.

Production of Antifoaming Agents which can be Used in Accordance with the Invention

In accordance with the invention, mineral oil antifoaming agents (for example Example 5 according to DE 32 45 482 A1) or alternatively silicone antifoaming agents (for example Example 8 according to DE 199 17 186 C1) can be used as antifoaming agents, for example.

Production of CNT Dispersions which can be Used in Accordance with the Invention

Materials: water, wetting agent or dispersing agent (according to the example), antifoaming agent (according to the example), MWCNTs (Baytubes® C150P)

Equipment: Attritor mill with beads, pump, storage container with stirring tool (dissolver)

### Exemplary Formulations:

| | |
|---|---|
| Antifoaming agent | 0.01% to 10% |
| Wetting agent or dispersing | 1% to 20% |
| agent | |
| MWCNTs | 3% to 10% |
| Water | to 100% |

### Production Method for 50 kg of a 3% CNT Dispersion in Water:

45.8 kg of water were added into a storage container and circulated constantly at low shear forces. 2.3 kg of wetting or dispersing agent were then added at low shear forces and were mixed further for approximately 10 minutes. 0.5 kg of antifoaming agent was then added slowly and also worked in at low shear forces for five minutes until the medium was absolutely homogeneous. 1.5 kg of carbon nanotubes were then added very slowly to the medium. In order to ensure constant circulation of the preliminary dispersion, it may be necessary to increase the shear forces of the dissolver as the CNT content increases. Once all components are in the storage container, the preliminary dispersion is stirred for 30 minutes at medium shear forces until it appears homogeneous. Continuous dispersion now occurs with backmixing by the attritor mill. The dispersion is fed by a pump to the attritor mill through a suction hosepipe at the drain valve of the storage container and is dispersed in the grinding chamber by zirconium oxide beads. A drain valve installed behind the grinding chamber is fixed above the storage container so that the dispersed part flows back into the storage container and is constantly mixed with the other part of the dispersion by the rotation of the dissolver. The continuous dispersion is carried out for five hours or until a glass discharge of the dispersion has a surface which is smooth, shiny and free from agglomerate.

### Description of the Attritor Mill:

Standard attritor mill from Hosokawa Alpine AG, 90 AHM and 132 AHM models

Selection of the equipment with the following objectives:
Breaking up of the hard granulate by grinding balls (size 1.4 to 1.7 mm or 2.0 to 2.5 mm at least)
Reduction of machine pressure (gap width of the screen cartridge >CNT granulate, 1 mm; large hosepipe diameter)
Optimisation of the cooling process (cooling of the double-wall grinding container, SiC feed hosepipe; cooling of the double-wall circulation tank)
Reduction of abrasion (use of a PU rotor)
Good circulation in the circulation tank (use of a dissolver disc)

### Description of the Dispersion Method (Chronologically):

Fill the carrier liquid into the circulation tank
Add the antifoaming agent (for example Byk® 028, BYK-Chemie GmbH): Homogenise by stirring using a dissolver disc
Add the dispersing additive (for example Byk® LP-N 6587, BYK-Chemie GmbH): Homogenise by stirring using a dissolver disc
Switch on the installation: Homogenise the solution in the mill
Add the CNTs in steps (adding in a single step is not advantageous due to a strong development of viscosity)
For 132 AHM/2.3 kg CNT/dispersion containing 8% solid 5% CNT after approximately 50 minutes in dispersion 6% CNT after approximately 110 minutes in dispersion 7% CNT after approximately 240 minutes in dispersion 8% CNT after approximately 370 minutes in dispersion
Further dispersing of the dispersion up to a defined time/defined energy input/defined dispersion quality

### Installation Description:

The entire installation is divided into three sub-installations, namely the dispersion unit (Hosokawa Alpine AG), high-pressure feed pump (ViscoTec) and extruder (Coperion). The dispersion unit (based on process) consists of a 132 AHM attritor mill (Hosokawa Alpine), 2 hosepipe pumps, 2×25 litre tanks with dissolver stirrers, 9 valves, hosepipe assembly.

Specific properties of the dispersion unit:
Operation possible in different modes (circulation mode, single-passage mode, pendulum mode)
Division of the installation possible for products which are very different
Minimisation of the idle time (parallel mixing during circulation grinding mode possible)

The results obtained in the individual tests with the relevant polymers are summarised in tables 1 to 4 below, wherein polyamide (PA) (Table 1), polyethylene (PE) (Table 2), polypropylene (PP) (Table 3) and thermoplastic elastomers (TPE) (Table 4) were used as plastics.

Key

| | |
|---|---|
| Temperature | Temperature in the heating block |
| Rotary speed | Rotary speed of the shaft |
| Throughput | Determined gravimetrically by balance |
| | control |
| Vacuum | Vacuum connected yes/no |
| Added medium | Dispersion name |
| Throughput of medium | Pump throughput |
| Capacity utilisation | Calculated from the motor output |
| Melt pressure | Screw tip discharge into the melt |
| Melt temperature | Screw tip discharge into the melt |
| Pump | Pump type |
| Feed | Metering device used |
| Feed pressure | Pressure during feed of the dispersion |
| Filler in compound | Desired concentration in the compound |
| Moisture content at 80° C. | Measured |
| Density | Measured (ISO 1183-1) |
| MVR 230° C./2.16 kg | Measured (ISO 1133) |
| Charpy impact toughness | Measured (ISO 179-2) |
| Charpy impact value | Measured (ISO 179-2) |
| Tensile modulus | Measured (ISO 527-1/-2) |
| Yield stress | Measured (ISO 527-1/-2) |
| Yield strain | Measured |
| Nom. elongation at failure | Measured |
| Electr. resistance | Measured |
| Surface resistance | Measured |
| Coefficient of viscosity | Measured (ISO 307) |

TABLE 1

| | | | | | | | Ca- | | | | | | Pro- |
|---|---|---|---|---|---|---|---|---|---|---|---|---|---|
| | | | | | | Through- | pacity | | | | | | portion |
| | | Ro- | Through- | | | put | utili- | | | | | Feed | of filler |
| | Temperature | tary | put | Vac- | Added | of medium | sation | Melt | Melt | | | pressure | % by |
| Test no. | ° C. | rpm | kg/h | uum | medium | ml/min | % | bar | ° C. | Pump | Feed | bar | wt. |
| PA-1 | 240/255/230/ | 600 | 10 | yes | Pure PA6 | — | 60-65 | 16 | 253 | — | — | — | |
| | 250/250/ | | | | | | | | | | | | |
| | 240/240 | | | | | | | | | | | | |
| PA-2 | see above | 600 | 10 | yes | Water | 35 | 66-73 | 20 | 246 | Viscotec | Capillary | 4 | |
| | | | | | | | | | | 3RD12 | tube | | |
| | | | | | | | | | | | 3 mm | | |
| PA-3 | 250/240/240/ | 600 | 10 | no | Pure PA6 | | 66-70 | 14 | 259 | | | | |
| | 230/230/ | | | | | | | | | | | | |
| | 230/240 | | | | | | | | | | | | |
| PA-13 | 250/245/230/ | 380 | 10 | yes | HA 52835-M | 10.1 | 83-88 | 21 | 257 | Viscotec | 6 mm | dec 13 | 0.5 |
| | 230/230/ | | | | CNT suspension | | | | | 3RD12 | | | |
| | 240/240 | | | | | | | | | | | | |
| PA-14 | 250/245/230/ | 420 | ″ | yes | HA 52835-M | 20.2 | 86-92 | 23 | 258 | Viscotec | 6 mm | 13.5-14.5 | 1 |
| | 230/230/ | | | | CNT suspension | | | | | 3RD12 | | | |
| | 240/240 | | | | | | | | | | | | |
| PA-15 | 250/245/230/ | 460 | ″ | yes | HA 52835-M | 30.5 | 86-94 | 24 | 259 | Viscotec | 6 mm | 13.5-15.2 | 1.5 |
| | 230/230/ | | | | CNT suspension | | | | | 3RD12 | | | |
| | 240/240 | | | | | | | | | | | | |
| PA-16 | 250/245/230/ | 490 | ″ | yes | HA 52835-M + L | 40.9 | 82-88 | 24 | 259 | Viscotec | 6 mm | 13.5-15.2 | 2 |
| | 230/230/ | | | | CNT suspension | | | | | 3RD12 | | | |
| | 240/240 | | | | | | | | | | | | |
| PA-17 | 250/245/230/ | 500 | ″ | yes | HA 52835-L | 51.4 | 83-89 | 23 | 259 | Viscotec | 6 mm | 13.5-14.5 | 2.5 |
| | 230/230/ | | | | CNT suspension | | | | | 3RD12 | | | |
| | 240/240 | | | | | | | | | | | | |
| PA-18 | 250/245/230/ | 500 | ″ | yes | HA 52835-L | 61.9 | 84-89 | 23 | 257 | Viscotec | 6 mm | 11.5-13.6 | 3 |
| | 230/230/ | | | | CNT suspension | | | | | 3RD12 | | | |
| | 240/240 | | | | | | | | | | | | |
| PA-19 | 250/245/230/ | 490 | 10 | yes | H,_{O+add.} | 30.6 | 77-81 | 24 | 262 | Viscotec | 6 mm | 6.0-9.0 | 0 |
| | 230/230/ | | | | LPN 6587 | | | | | 3RD12 | | | |
| | 240/240 | | | | | | | | | | | | |
| PA-20 | 250/245/230/ | 300 | 6 | yes | HA 52835-L | 87 | 76-86 | 13 | 247 | Viscotec | 6 mm | ? | approx. |
| | 230/230/ | | | | CNT suspension | | | | | 3RD12 | | | 6.8 |
| | 240/240 | | | | | | | | | | | | |

| | | | | | | | | | | | | | Surface | Surface |
|---|---|---|---|---|---|---|---|---|---|---|---|---|---|---|
| | | | | | | | | | | | | | resis- | resis- |
| | | | | Coef- | | | | | | | | | tance | tance |
| | Mois- | | | ficient | | Charpy | Charpy | | | | Nom. | Nom. | 1 (on | 2 (on |
| | ture | Ignition | Den- | of | MVR | impact | impact | Tensile | Yield | Yield | yield | elongation | pressed | pressed |
| | content | residue | sity | [symbol] | 275° C./5 kg | toughness | value | modulus | stress | strain | strain | at failure | plates) | plates) |
| Test no. | % | % | g/cm³ | g/cm³ | cm³/10 min | kJ/m² | kJ/m² | MPa | MPa | % | % | % | Ohm | Ohm |
| PA-1 | | | | 144 | | 122.5 | 1.9 | 2893 | 72.7 | 8.2 | 25.4 | | | |
| PA-2 | | | | 144 | | 176.5 | 1.8 | 2925 | 69.5 | 7.6 | 10.4 | | | |
| PA-3 | 0.18 | | | 142 | 110 | 90.6 | 1.8 | 2913 | 72.5 | 8.2 | | | | |
| PA-13 | | | | | | | | | | | | | 1.00E+08 | 1.00E+08 |
| PA-14 | | | | | | | | | | | | | 1.00E+08 | 1.00E+08 |
| PA-15 | | | | | | | | | | | | | 1.00E+08 | 1.00E+08 |
| PA-16 | 0.13 | 1.97 | 1.13 | 161 | 59.6 | K.B. | 5.5 | 2323 | 61.4 | 10.3 | | 50.9 | 1.00E+08 | 1.00E+08 |
| PA-17 | | | | | | | | | | | | | 1.00E+08 | 1.00E+08 |
| PA-18 | | | | | | | | | | | | | 1.00E+08 | 1.00E+08 |
| PA-19 | 0.47 | — | 1.13 | 173 | — | K.B. | 2.8 | 2409 | 57.9 | 10.7 | | 87 | 1.00E+08 | 1.00E+08 |
| PA-20 | 0.37 | 9.45 | 1.16 | 143 | 54.5 | K.B. | 10 | 1834 | 48 | 36.9 | | 91.2 | 9.40E+04 | 2.44E+05 |

[symbol]

indicates data missing or illegible when filed

TABLE 2

| | Temperature | Rotary | Throughput | | | Throughput of medium | Capacity utilisation | Melt | Melt temperature | | | Feed pressure |
|---|---|---|---|---|---|---|---|---|---|---|---|---|
| Test no. | ° C. | rpm | kg/h | Vacuum | Added medium | ml/min | % | bar | ° C. | Pump | Feed | bar |
| PE-1 | 200/190/180/ | 580 | 10 | yes | H2O | 26 | 78-85 | 44 | 213 | Viscotec | Capillary | 17-26 |
| | 180/190/190/200 | | | | | | | | | 3RD12 | tube 6 mm | |
| PE-2 | see above | 750 | 10 | yes | H2O + Byk | 31 | 46-50 | 43 | 207 | Viscotec | Capillary | 9-14 |
| | | | | | LPN6587 | | | | | 3RD12 | tube 6 mm | |
| | see above | 400 | see | see | see | see | 75-80 | 49 | see | Viscotec | Capillary | 18-21 |
| | | | above | above | above | above | | | above | 3RD12 | tube 6 mm | |
| PE-3 | see above | 400 | 10 | yes | 52835-F | 46 | 75-80 | 39 | 205 | Viscotec | Capillary | 22-30 |
| | | | | | | | | | | 3RD12 | tube 6 mm | |
| PE-4 | see above | 500 | 10 | yes | 52835-F | 46 | 54-60 | 23 | 202 | Viscotec | Capillary | 23-24 |
| | | | | | | | | | | 3RD12 | tube 6 mm | |
| PE-5 | see above | 380 | 10 | yes | 52835-E | 34 | 84-90 | 48 | 207 | Viscotec | Capillary | 19-28 |
| | | | | | | | | | | 3RD12 | tube 6 mm | |
| PE-6 | 200/190/180/ | 500 | 10 | yes | — | — | 79-88 | 44 | 214 | Viscotec | — | — |
| | 180/190/190/200 | | | | | | | | | 3RD12 | | |
| PE-7 | 200/205/180/180/ | 550 | 9.8 | yes | CNT powder | | 80-88 | 45 | 215 | Viscotec | — | — |
| | 190/190/200 | | | | | | | | | 3RD12 | | |
| PE-7 | 200/205/180/180/ | 600 | 9.5 | yes | CNT powder | | 80-88 | 46 | 217 | Viscotec | — | — |
| | 190/190/200 | | | | | | | | | 3RD12 | | |
| PE-9 | 190/190/180/ | 450 | 10 | yes | 52835-I | 68 | 70-75 | 19 | 197 | Viscotec | Capillary | 24-27 |
| | 180/190/190/200 | | | | | | | | | 3RD12 | tube 6 mm | |
| PE-10 | 190/190/180/ | 450 | 10 | yes | 52835-I | 91 | 76-83 | 19 | 199 | Viscotec | Capillary | 26-30 |
| | 180/190/190/200 | | | | | | | | | 3RD12 | tube 6 mm | |
| PE-11 | 190/190/180/ | 450 | 10 | yes | 52835-I | 94 | 74-83 | 19 | 199 | Viscotec | Capillary | 26-30 |
| | 180/190/190/200 | | | | | | | | | 3RD12 | tube 6 mm | |
| PE-12 | 190/190/180/ | 480 | 10 | yes | 52835-H | 34 | 80-86 | 46 | 211 | Viscotec | Capillary | 23-26 |
| | 180/190/190/200 | | | | | | | | | 3RD12 | tube 6 mm | |
| PE-13 | 190/190/180/ | 450 | 10 | yes | 52835-H | 69 | 74-82 | 19 | 199 | Viscotec | Capillary | 25-29 |
| | 180/190/190/200 | | | | | | | | | 3RD12 | tube 6 mm | |
| PE-14 | 190/190/180/ | 600 | 10 | yes | 090224-255 | 34 | 80-85 | 40-45 | 217 | Viscotec | Capillary | 17-21 |
| | 180/190/190/200 | | | | | | | | | 3RD12 | tube 6 mm | |
| PE-15 | 190/190/180/ | 600 | 10 | yes | 090224-255 | 17 | 79-83 | 39-44 | 218 | Viscotec | Capillary | 16-20 |
| | 180/190/190/200 | | | | | | | | | 3RD12 | tube 6 mm | |
| PE-16 | 190/190/180/ | 600 | 10 | yes | 090224-255 | 25 | 79-85 | 39-43 | 218 | Viscotec | Capillary | 19-22 |
| | 180/190/190/200 | | | | | | | | | 3RD12 | tube 6 mm | |
| PE-17 | 190/190/180/ | 600 | 10 | yes | 090224-255 | 8.5 | 81-86 | 40-44 | 219 | Viscotec | Capillary | 17-22 |
| | 180/190/190/200 | | | | | | | | | 3RD12 | tube 6 mm | |
| PE-18 | 190/190/180/ | 600 | 10 | yes | 090224-255 | 42.5 | 79-84 | 38-43 | 219 | Viscotec | Capillary | 16-22 |
| | 180/190/190/200 | | | | | | | | | 3RD12 | tube 6 mm | |
| PE-19 | 190/190/180/190/ | 400 | 10 | yes | H2O + | 30.6 | 75-82 | 50 | 208 | Viscotec | 6 mm | 11-17 |
| | 190/190/200 | | | | Add.LPN- | | | | | 3RD12 | | |
| | | | | | 6587 | | | | | | | |

| | Filler | Moisture | | | | | | | | | | | | |
|---|---|---|---|---|---|---|---|---|---|---|---|---|---|---|
| | in the | content at | | MVR | Impact | Impact | Tensile | Yield | Yield | Nom. elongation at | Electr. | Surface resistance | Surface resistance | Surface resistance |
| | [symbol] | 80° C. | Density | 230° C./2.16 kg | toughness | value | modulus | stress | strain | failure | resistance | (on pressed plates) | (on pressed plates) | (on pressed plates) |
| Test no. | % | % | g/cm³ | cm³/10 min | kJ/m² | kJ/m² | MPa | MPa | % | % | Ohm | Ohm | Ohm | Ohm |
| PE-1 | 2 | 0.08 | 0.95 | 1.6 | KB | 14.2 | 915 | 14.1 | 8.5 | 55.3 | >10¹² | | | |
| PE-2 | 2 | 0.16 | 0.95 | 1.9 | KB | 16.4 | 877 | 21.5 | 14.9 | 51.9 | >10¹² | | | |
| | 2 | | | | | | | | | | | | | |
| PE-3 | 2 | 0.204 | 0.96 | 1.7 | KB | 10.3 | 1013 | 22.4 | 14.6 | 41.5 | >10¹² | | | |
| PE-4 | 2 | 0.480 | 0.91 | 1.8 | KB | 110.8 | 935 | 21.5 | 14.1 | 24.9 | >10¹² | | | |
| PE-5 | 2 | 0.22 | 0.96 | 1.5 | KB | 10.58 | 934 | 22.8 | 14.6 | 46.1 | >10¹² | | | |
| PE-6 | — | 0.06 | 0.94 | 1.7 | KB | 15.7 | 801 | 21.5 | 14.5 | 68.4 | | | | |
| PE-7 | 2 | 0.05 | 0.95 | 1.5 | KB | 7.6 | 866 | 22.0 | 13.7 | 61.0 | | | | |
| PE-7 | 5 | 0.05 | 0.97 | 1.0 | KB | 5.6 | 946 | 23.7 | 13.9 | 36.6 | | | | |
| PE-9 | 3 | | 0.91 | 1.30 | 46.1 | 10.5 | 768 | 19.3 | 14.1 | 35.7 | >10¹² | 4.19E+02 | 5.96E+02 | 2.78E+02 |
| PE-10 | 4 | | 0.91 | 1.10 | KB | 9.9 | 766 | 19.9 | 13.4 | 23.2 | >10¹² | 2.04E+02 | 3.23E+02 | 1.13E+02 |
| PE-11 | 4.1 | | 0.92 | 0.97 | 86.5 | 8.6 | 781 | 20.3 | 14.3 | 21.3 | >10¹² | 2.38E+02 | 2.75E+02 | 1.32E+02 |
| PE-12 | 1 | | 0.96 | 1.50 | 107.2 | 10.6 | 898 | 21.6 | 14.0 | 48.4 | >10¹² | 1.00E+08 | 1.00E+08 | 1.00E+11 |
| PE-13 | 2 | | 0.90 | 1.40 | 105.6 | 9.9 | 777 | 19.8 | 14.6 | 27.2 | >10¹² | 4.91E+03 | 5.23E+03 | 2.43E+03 |
| PE-14 | 2.1 | | 0.96 | 2.10 | 129.2 | 7.5 | 757 | 22 | 13.2 | 118.6 | n.g. | >10E+07 | >10E+07 | 1.00E+11 |
| PE-15 | 1 | | | | | | | | | | | >10E+07 | >10E+07 | 1.00E+11 |
| PE-16 | 1.5 | | | | | | | | | | | >10E+07 | >10E+07 | 9.75E+10 |
| PE-17 | 0.5 | | | | | | | | | | | >10E+07 | >10E+07 | 1.00E+11 |
| PE-18 | 2.6 | | | | | | | | | | | | | |
| PE-19 | 0 | 0.12 | 0.95 | 2.6 | 124.2 | 17.7 | 869 | 9.9 | 6.1 | 52.8 | | 1.00E+08 | 1.00E+08 | |

[symbol]

indicates data missing or illegible when filed

TABLE 3

| | | | | | | | Ca- | | | | | | Pro- |
|---|---|---|---|---|---|---|---|---|---|---|---|---|---|
| | | | | | | Through- | pacity | | | | | | portion |
| | | Ro- | Through- | | | put | utili- | | | | | Feed | of |
| | Temperature | tary | put | Vac- | Added | of medium | sation | Melt | Melt | | | pressure | filler |
| Test no. | ° C. | rpm | kg/h | uum | medium | ml/min | % | bar | ° C. | Pump | Feed | bar | % |
| PP | Raw material as | | | | | | | | | | | | |
| | reference | | | | | | | | | | | | |
| | (datasheet | | | | | | | | | | | | |
| | values) | | | | | | | | | | | | |
| PP-0 | Raw material as | | | | | | | | | | | | |
| | reference (Bada | | | | | | | | | | | | |
| | measured values) | | | | | | | | | | | | |
| PP-1 | 180/210/190/190/ | 200 | 5 | 1x | | | 50-60 | 19 | | | | | |
| | 200/190/190 | | | | | | | | | | | | |
| PP-2 | 180/200/190/190/ | 200 | 5 | 1x | H₂O | 6.6 | 50-61 | 20 | | Viscotec | Viscotec | 10 | |
| | 200/190/190 | | | | | | | | | | 3RD12 | | |
| PP-55 | 200/200/190/200/ | 220 | 10 | yes | HA 52935-L | 10.1 | 77-86 | 19 | 229 | 1.3 | Viscotec | 13-16 | 0.5 |
| | 210/210/220 | | | | | | | | | | 3RD12 | | |
| PP-56 | | 220 | 10 | | HA 52935-L | 20.2 | 76-84 | 19 | 228 | 2.6 | Viscotec | 14-17 | 1 |
| | | | | | | | | | | | 3RD12 | | |
| PP-57 | | 280 | 10 | | HA 52935-L | 30.5 | 63-70 | 18 | 227 | 4 | Viscotec | 16-20 | 1.5 |
| | | | | | | | | | | | 3RD12 | | |
| PP-58 | | 280 | 10 | | HA 52935-L | 40.9 | 64-74 | 20 | 226 | 5.2 | Viscotec | 19-21 | 2 |
| | | | | | | | | | | | 3RD12 | | |
| PP-59 | | 280 | 10 | | HA 52935-L | 51.4 | 69-79 | 20 | 225 | 6.4 | Viscotec | 20-23 | 2.5 |
| | | | | | | | | | | | 3RD12 | | |
| PP-60 | | 300 | 10 | | HA 52935-K | 61.9 | 66-71 | 21 | 220 | 7.5 | Viscotec | 21-23 | 3 |
| | | | | | | | | | | | 3RD12 | | |
| PP-61 | | 220 | 10 | | H2O + Add. | 30.6 | 70-76 | 17 | 225 | 4 | Viscotec | 10.5-12.8 | |
| | | | | | LP-6587 | | | | | | 3RD12 | | |

| | | | | | | | | | | | | Surface | Surface |
|---|---|---|---|---|---|---|---|---|---|---|---|---|---|
| | | | | | | | | | | | | resis- | resis- |
| | | | | | | | | | | | | tance | tance |
| | | | | | Charpy | Charpy | | | | Nom. | Nom. | 1 (on | 2 (on |
| | | Ignition | Den- | MVR | impact | impact | Tensile | Yield | Yield | yield | elongation | pressed | pressed |
| | Moisture | residue | sity | 230° C./2.16 kg | toughness | value | modulus | stress | strain | strain | at failure | plates) | plates) |
| Test no. | % | % | g/cm³ | cm³/10 min | kJ/m² | kJ/m² | MPa | MPa | % | % | % | Ohm | Ohm |
| PP | | | | 21 | | 8.0 | 1450 | 27.0 | 8.0 | | | | |
| | | | | (g/10 min) | | | | | | | | | |
| PP-0 | 0 | | | 24.6 | 139.7 | 8.6 | 1860 | 26.8 | 6.0 | 30.6 | | | |
| PP-1 | 0.01 | | | 27.0 | 130.3 | 6.4 | 1517 | 24.2 | 6.5 | 43.9 | | | |
| PP-2 | 0 | | | 27.3 | 106.3 | 7.1 | 1460 | 23.6 | 7.1 | 40.3 | | | |
| PP-55 | | | | | | | | | | | | 1.00E+08 | 1.00E+08 |
| PP-56 | | | | | | | | | | | | 1.00E+08 | 1.00E+08 |
| PP-57 | | | | | | | | | | | | 1.00E+08 | 1.00E+08 |
| PP-58 | 0.141 | | 0.91 | 18.4 | 163.5 | 8.5 | 1333 | 23.4 | 6.9 | | 109.6 | 1.00E+08 | 1.00E+08 |
| PP-59 | | | | | | | | | | | | 5.69E+03 | 7.46E+03 |
| PP-60 | | | | | | | | | | | | 1.20E+05 | 1.10E+05 |
| PP-61 | 0.12 | | 0.90 | 18.6 | 140.8 | 7.7 | 1181 | 23.0 | 7.9 | | 28.1 | 1.00E+08 | 1.00E+08 |

TABLE 4

| | | | | | | | Ca- | | | | | | Pro- |
|---|---|---|---|---|---|---|---|---|---|---|---|---|---|
| | | | | | | Through- | pacity | | | | | | portion |
| | | | | | | put | utili- | | | Pump | | Feed | of |
| | Temperature | Rotary | Throughput | Vac- | Added | of medium | sation | Melt | Melt | setting | | pressure | filler |
| Test no. | ° C. | rpm | kg/h | uum | medium | ml/min | % | bar | ° C. | Stage | Feed | bar | % |
| TPE-0 | 190/190/190/190/ | 250 | 10 | yes | | | 47-50 | 14 | 208 | | | | 0 |
| | 190/190/200 | | | | | | | | | | | | |
| TPE-1 | | 250 | 10 | | HA 52935-K | 10.1 | 49-51 | 14 | 207 | Viscotec | 6 mm | 9.8-10.8 | 0.5 |
| | | | | | | | | | | 3RD12 | | | |
| TPE-2 | | 250 | 10 | | HA 52935-K | 20.2 | 49-51 | 14 | 207 | Viscotec | | 10.4-11 | 1 |
| | | | | | | | | | | 3RD12 | | | |
| TPE-3 | | 250 | 10 | | HA 52935-K | 30.5 | 55-59 | 15 | 206 | Viscotec | | 10.5-11.5 | 1.5 |
| | | | | | | | | | | 3RD12 | | | |
| TPE-4 | | 250 | 10 | | HA 52935-K | 40.9 | 50-53 | 15 | 205 | Viscotec | | 10.4-12.8 | 2 |
| | | | | | | | | | | 3RD12 | | | |
| TPE-5 | | 250 | 10 | | HA 52935-K | 51.4 | 50-54 | 15 | 203 | Viscotec | | 13.0-15.0 | 2.5 |
| | | | | | | | | | | 3RD12 | | | |
| TPE-6 | | 250 | 10 | | HA 52935-K | 61.9 | 53-56 | 16 | 201 | Viscotec | | 14.4-15.0 | 3 |
| | | | | | | | | | | 3RD12 | | | |
| TPE-7 | | 250 | 10 | | H2O + Add. | 30.6 | 44-46 | 13 | 204 | Viscotec | | 8.0-9.0 | 0 |
| | | | | | LP-6587 | | | | | 3RD12 | | | |

| | | | | | | Longitudinal | |
|---|---|---|---|---|---|---|---|
| | | | | Longitudinal | Transverse | elongation at | Transverse |
| | Density | MVR (230/2.16 kg) | Shore hardness | tensile strength | tensile strength | failure | elongation at |
| Test no. | g/cm³ | cm³/10 min | A | MPa | MPa | % | % |
| TPE-0 | 1.10 | 7.7 | 89 | 9.75 | 9.64 | 651 | 694 |
| TPE-1 | | | | | | | |
| TPE-2 | | | | | | | |
| TPE-3 | | | | | | | |
| TPE-4 | 1.11 | 8.2 | 89 | 8.88 | 9.54 | 619 | 742 |
| TPE-5 | | | | | | | |
| TPE-6 | | | | | | | |
| TPE-7 | 1.10 | 12.2 | 90 | 9.65 | 9.32 | 642 | 653 |

Further test results are shown in Table 5 below:

TABLE 5

| | | | | | Measure- | |
|---|---|---|---|---|---|---|
| | | Pressed | Pressing | Conductivity | ment | |
| Test | Comments | plates | temp. | Ω/square | voltage V | TEM |
| PE-3 | | x | 220° C. | 2.53E+04 | 9 | |
| PE-5 | | x | 220° C. | 9.17E+03 | 9 | |
| PE-9 | | x | 220° C. | 2.78E+02 | 9 | |
| PE-10 | | x | 220° C. | 1.13E+02 | 9 | |
| PE-11 | | x | 220° C. | 1.32E+02 | 9 | |
| PE-12 | | x | 220° C. | >1.00E+11 | 9 | |
| PE-13 | | x | 220° C. | 2.43E+03 | 9 | |
| PE-14 | | x | 220° C. | >1.00E+11 | 100 | |
| PE-15 | | x | 220° C. | >1.00E+11 | 100 | |
| PE-16 | | x | 220° C. | 9.75E+10 | 100 | |
| PE-17 | | x | 220° C. | >1.00E+11 | 100 | |
| PE-18 | | x | 220° C. | >1.00E+11 | 100 | |
| PE-19 | without | — | 220° C. | 2.43E+03 | 9 | |
| | CNT | | | | | |
| PE-20 | | x | 220° C. | >1.00E+11 | 100 | |
| PE-21 | | x | 220° C. | 4.00E+10 | 100 | |
| PE-22 | | x | 220° C. | 2.48E+07 | 100 | |
| PE-23 | | x | 220° C. | 5.18E+04 | 9 | x |
| PE-24 | | x | 220° C. | 2.24E+03 | 9 | |
| PE-25 | | x | 220° C. | 4.59E+02 | 9 | |
| PE-26 | | x | 220° C. | >1.00E+11 | 100 | |
| PE-27 | | x | 220° C. | 5.51E+10 | 100 | |
| PE-28 | | x | 220° C. | 1.37E+07 | 9 | |
| PE-29 | | x | 220° C. | 3.77E+04 | 9 | |
| PE-30 | | x | 220° C. | 6.60E+02 | 9 | |
| PE-31 | | x | 220° C. | 3.72E+02 | 9 | |
| PP-55 | | x | 200° C. | >1.00E+11 | 100 | |
| PP-56 | | x | 200° C. | 8.26E+10 | 100 | |
| PP-57 | | x | 200° C. | 1.48E+09 | 100 | |
| PP-58 | | x | 200° C. | 4.27E+04 | 9 | x |
| PP- | | x | 200° C. | 1.17E+03 | 9 | |
| 59-1 | | | | | | |
| PP- | | x | 200° C. | 7.12E+03 | 9 | |
| 59-2 | | | | | | |
| PP-61 | without | — | 200° C. | | | |
| | CNT | | | | | |
| PA-13 | | x | 280° C. | >1.00E+11 | 100 | |
| PA-14 | | x | 280° C. | 1.94E+10 | 100 | |
| PA-15 | | x | 280° C. | 6.42E+04 | 9 | |
| PA-16 | | x | 280° C. | 1.35E+03 | 9 | x |
| PA-17 | | x | 280° C. | 9.68E+02 | 9 | |
| PA-18 | | x | 280° C. | 9.72E+02 | 9 | |
| PA-19 | without | — | 280° C. | | | |
| | CNT | | | | | |

1-15. (canceled)

16. A method for producing a composite material based on at least one polymer on the one hand and on carbon nanotubes (CNTs) on the other hand, wherein the method includes the following method steps:
(a) providing a dispersion or solution of carbon nanotubes (CNTs) in a continuous liquid phase by dispersing or solubilising carbon nanotubes (CNTs) in a dispersion medium or solvent,
the dispersion or solution being produced in method step (a) by mixing in the continuous phase with an input of pressure and/or with ultrasonic input, and the carbon nanotubes (CNTs) being used in a concentration of 0.001 to 30% by weight, based on the resultant dispersion or solution; then
(b) introducing the dispersion or solution of carbon nanotubes (CNTs) produced in method step (a) into the melt of at least one polymer with homogenisation and with removal of the continuous phase;
the dispersion or solution of carbon nanotubes (CNTs) produced in method step (a) being introduced into the melt of the polymer by means of a feed pump and/or metering pump with an application of pressure and at constant metering rate and/or with constant metering accuracy,
method step (b) being carried out in an extrusion apparatus, said extrusion apparatus comprising mixing means for homogenising the dispersion or solution of carbon nanotubes (CNTs) produced in method step (a) with the melt of the polymer, and/or comprising a degassing device for the purposes of removing the continuous liquid phase, and
a residual content of continuous phase of 1% by weight at most, based on the end product, being set; then
(c) leaving to cool the mixture of molten polymer and carbon nanotubes (CNTs) obtained in method step (b) until the polymer has solidified, and then obtaining a composite material which contains at least one polymer and carbon nanotubes (CNTs).

17. The method according to claim 16, wherein a thermoplastic polymer is used as the polymer, selected from the group of polyamides, polyacetates, polyketones, polyolefins, polycarbonates, polystyrenes, polyesters, polyethers, polysulfones, polyfluoropolymers, polyurethanes, polyamide imides, polyarylates, polyarylsulfones, polyethersulfones, polyarylsulfides, polyvinyl chlorides, polyether imides, polytetrafluoroethylenes, polyether ketones, polylactates, and mixtures and copolymers thereof.

18. The method according to claim 16, wherein the polymer used is selected from thermoplastic polymers, from the group of polyamides; polyolefins; polyethylene terephthalates (PETs) and polybutylene terephthalates (PBTs); thermoplastic elastomers (TPEs), olefin-based thermoplastic elastomers (TPE-Os or TPOs), cross-linked olefin-based thermoplastic elastomers (TPE-Vs or TPVs), urethane-based thermoplastic elastomers (TPE-Us or TPUs), thermoplastic copolyesters (TPE-Es or TPCs), thermoplastic styrene block copolymers (TPE-S or TPS), thermoplastic copolyamides (TPE-As or TPAs); thermoplastic acrylonitrile/butadiene/styrene (ABS); polylactates (PLAs); polymethyl(meth)acrylates (PMAs or PMMAs); polyphenylene sulphides (PPS); and mixtures and copolymers thereof.

19. The method according to claim 16, wherein the dispersion or solubilisation of the carbon nanotubes (CNTs) carried out in method step (a) takes place in an attritor mill and/or with ultrasonic input, or wherein the dispersion or solubilisation of carbon nanotubes (CNTs) carried out in method step (a) is achieved by means of high-shear dispersion.

20. The method according to claim 16, wherein the carbon nanotubes (CNTs) are used in a concentration of 0.01 to 20% by weight, based on the resultant dispersion or solution.

21. The method according to claim 16, wherein the dispersion or solution is produced in method step (a) by addition of the carbon nanotubes (CNTs) into the continuous liquid phase in steps or in batches.

22. The method according to claim 16, wherein in method step (a), method step (a) is carried out in the presence of at least one dispersing agent (dispersant), the dispersing agent (dispersant) being used in amounts of 10 to 300% by weight, based on the carbon nanotubes (CNTs), and/or the dispersing agent (dispersant) being selected from the group of wetting agents and surfactants, the dispersing agent (dispersant) having a number average molecular weight of at least 1,000 g/mol; and/or wherein method step (a) is carried out in the presence of at least one antifoaming agent, selected from the group of mineral oil-based or silicone-based antifoaming agents, and/or in amounts of 0.1 to 300% by weight, based on the carbon nanotubes (CNTs), and/or in amounts of 0.01 to 20% by weight, based on the dispersion or solution.

23. The method according to claim 16, wherein an aqueous, an organic or an aqueous-organic solvent or dispersion medium is used as a continuous liquid phase, and/or wherein a solvent or dispersion medium present in the liquid aggregate state under dispersion or solubilisation conditions is used as a continuous liquid phase; and/or wherein the continuous phase has a boiling point at atmospheric pressure (101.325 kPa) in a temperature range of 20 to 300° C.; and/or wherein the dispersion or solution of carbon nanotubes (CNTs) produced in method step (a) is introduced at a feed pressure of 2 to 100 bar.

24. The method according to claim 16, wherein the extrusion apparatus is formed as a screw extruder; and/or wherein the extrusion apparatus is divided into a plurality of sections, including a first section for introduction of the at least one polymer, followed by a melt section for melting the polymer, then followed by a feed section for feeding the dispersion or solution of carbon nanotubes (CNTs), then followed by a homogenisation and degassing section, which then joins to a discharge section.

25. The method according to claim 16, wherein the carbon nanotubes (CNTs) are incorporated in amounts of 0.001 to 20% by weight, based on the composite material formed of polymer and carbon nanotubes (CNTs).

26. The method according to claim 16,
wherein the carbon nanotubes (CNTs) used are selected from single-wall carbon nanotubes (SWCNTs or SWNTs) or multi-wall carbon nanotubes (MWCNTs or MWNTs), and/or
wherein the carbon nanotubes (CNTs) used have mean inner diameters of 0.4 to 50 nm, and/or
wherein the carbon nanotubes (CNTs) used have mean outer diameters of 1 to 60 nm, and/or
wherein the carbon nanotubes (CNTs) used have mean lengths of 0.01 to 1,000 μm, and/or
wherein the carbon nanotubes (CNTs) used have a tensile strength per carbon nanotube of at least 1 GPa, and/or
wherein the carbon nanotubes (CNTs) used have a modulus of elasticity per carbon nanotube of at least 0.1 TPa, and/or
wherein the carbon nanotubes (CNTs) used have a thermal conductivity of at least 500 W/mK, and/or
wherein the carbon nanotubes (CNTs) used have an electrical conductivity of at least 10³ S/cm, and/or
wherein the carbon nanotubes (CNTs) used have a bulk density in the range of 0.01 to 0.3 g/cm³.

27. The method according to claim 16, wherein the carbon nanotubes used are of the cylinder type, scroll type or the type having an onion-like structure, and/or are single-walled or multi-walled, and/or wherein the carbon nanotubes (CNTs) used have a ratio of length to outer diameter of ≧5, and/or wherein the carbon nanotubes (CNTs) are used in the form of agglomerates, the agglomerates having a mean diameter in the range of 0.05 to 5 mm, and/or wherein the carbon nanotubes (CNTs) used have a mean diameter of 3 to 100 nm, and/or wherein the carbon nanotubes (CNTs) of the scroll type having a plurality of graphene layers, which are combined to form a stack or are rolled up, are selected.

28. The method according to claim 16, wherein the method is carried out continuously or semi-continuously, method step (a) being carried out discontinuously and/or the subsequent method steps (b) and (c) being carried out continuously.

29. A composite material, containing at least one polymer on the one hand and carbon nanotubes (CNTs) on the other hand, said composite material being obtainable by a method according to claim 16.

30. The composite material according to claim 29, containing at least one polymer on the one hand and carbon nanotubes (CNTs) on the other hand, the composite material having a content of carbon nanotubes (CNTs) of 0.001 to 20% by weight, based on the composite material.

31. The composite material according to claim 29, containing at least one dispersing agent (dispersant) in amounts of 0.01 to 300% by weight, based on the carbon nanotubes (CNTs).

32. The composite material according to claim 29, containing at least one antifoaming agent, in amounts of 0.01 to 200% by weight, based on the carbon nanotubes (CNTs).

33. The composite material according to claim 29, having a surface resistance of less than 10⁸ ohm.

34. The composite material according to claim 29, having a volume resistance of less than 10¹² ohm·cm.

35. A structure selected from the group consisting of conductive or semiconductive component parts, conductive or semiconductive components, conductive or semiconductive structures and conductive or semiconductive apparatuses, said structure comprising a composite material according to claim 29.

36. The structure according to claim 35 for the field of electronics and electrical engineering, computer and semiconductor engineering and industries, metrology and the associated industry, aeronautical and aerospace engineering, the packing industry, the automotive industry and cooling technology.
